(19) United States
(12) Patent Application Publication
(10) Pub. No.: US 2026/0214304 A1
(43) Pub. Date: Jul. 23, 2026

(54) SYSTEMS AND METHODS FOR AI-ASSISTED AUTOMATED MULTIMEDIA GENERATION AND MANAGEMENT

(71) Applicant: Giant Labs, Inc., San Francisco, CA (US)

(72) Inventors: John KOBS, San Francisco, CA (US); David SILVERMAN, Brooklyn, NY (US)

(21) Appl. No.: 19/455,685

(22) Filed: Jan. 21, 2026

Related U.S. Application Data
(60) Provisional application No. 63/748,007, filed on Jan. 22, 2025.

(51) Int. Cl. H04N 21/81; G06N 20/00; H04N 21/84; H04N 21/854

(52) U.S. Cl. CPC H04N 21/816; G06N 20/00; H04N 21/84; H04N 21/854

(57) ABSTRACT

Systems and methods for computer-implemented generation of an automated workflow that transforms user prompts into multimedia content using multiple artificial intelligence (“AI”) driven stages, including receiving user input and generating, in real time, user-appropriate and tailored content, using a sequence of content generation steps associated with an automated workflow to generate video, audio, and/or text content responsive to the user prompt for content generation, using machine learning models, and content tables. There is a structured metadata or reference mechanism, which includes automated feedback and regeneration loops that help maintain narrative, visual, and asset consistency across stages and across different AI models, enabling regeneration or correction, when appropriate. The systems and methods enable monitoring of the outputs received and enable creation of a biasing protocol and implementing the biasing protocol, whereby a content generation pipeline is created, including the selection, sequencing, and coordination of multiple AI models or agents to transform a user input into a finalized multimedia output.

### TECHNICAL FIELD

Embodiments of this disclosure relate generally to the field of automated multimedia content generation and more particularly to the automation of the design and generation of customized multimedia content assisted by artificial intelligence.

### BACKGROUND

The present invention relates to display and automated generation of multimedia content that is tailored to a user request for content generation, and more specifically, to providing dynamically created and modified streaming multimedia content.

Conventional streaming multimedia content systems primarily rely on pre-generated and pre-edited material stored in centralized databases. These systems are limited in their ability to adapt the presentation of multimedia content dynamically to meet specific user preferences or contextual needs. Typically, users interact with static libraries where the content is retrieved and delivered based on pre-defined metadata or categories. While effective for delivering on-demand video or audio, these systems fail to account for real-time customization or generation of multimedia elements that could enhance user engagement and satisfaction.

Furthermore, existing technologies that do offer some level of user-customization often require significant manual intervention for content curation, editing, and personalization. Such systems can be particularly inefficient when handling large-scale content libraries or addressing highly diverse user requests. Additionally, reliance on static content and manual workflows often limits scalability.

Current solutions for interactive multimedia content generation also face limitations in integrating user inputs effectively. For example, platforms that offer limited customization options often do so within narrowly defined frameworks, such as static playlists, restricted video editing tools, or predefined templates. As a result, users are unable to influence the multimedia content at a granular level or receive highly personalized outputs that align with their specific preferences or contextual needs.

The rapid proliferation of user-generated content platforms has led to a growing demand for dynamic, context-sensitive multimedia experiences. Existing systems are ill-equipped to handle scenarios where real-time content generation, adaptive rendering, or responsive multimedia delivery is required to meet user expectations. This gap has created a need for innovative solutions that can bridge the divide between static content delivery and real-time, user-tailored multimedia content generation.

### SUMMARY

The figures and the detailed description that follow more particularly exemplify various embodiments.

### BRIEF DESCRIPTION OF THE DRAWINGS

This disclosure may be more completely understood in consideration of the following description of various embodiments in connection with the accompanying figures, in which:

FIG. 1 is a conceptual block diagram of a computer system according to an embodiment.

FIG. 2A depicts an example content generation system user interface, in accordance with various implementations.

FIG. 2B depicts an example content generation system user interface, in accordance with various implementations.

FIG. 3 depicts an example content generation system user interface, in accordance with various implementations.

While various embodiments are amenable to various modifications and alternative forms, specifics thereof have been shown by way of example in the drawings and will be described in detail. It should be understood, however, that the intention is not to limit the disclosure or claims to the particular embodiments described. On the contrary, the intention is to cover all modifications, equivalents, and alternatives falling within the spirit and scope of the subject matter as defined by the claims.

### DETAILED DESCRIPTION

The present disclosure is directed to systems and methods for automating the dynamic generation, modification, and delivery of multimedia content in response to specific user requests assisted by artificial intelligence (AI). Using AI to automate the generation of multimedia content provides numerous advantages, as will become apparent from this disclosure.

AI is a rapidly developing and evolving field of computer science technology in which computers use learning and intelligence to take actions. Though examples of AI systems and technologies presently applicable to embodiments of this disclosure are included throughout this description, these examples are not limiting but rather provided as evidence of enablement of various features and aspects.

One field of AI is machine learning (ML), in which computer-implemented algorithms can be trained by and learn from data in order to generalize new or unseen data. ML can be, or can include, a large language model (LLM), which is an AI model (in particular, an artificial neural network, or ANN) that can understand and generate language. Conventional examples of LLMs include GPT, GEMINI, LLAMA, CLAUDE, and others. While examples discussed herein may use or apply ML and LLMs, other types of AI may be used in embodiments of the systems and methods of this disclosure without being limited by any particular mention or example related to ML used herein. Furthermore, examples or types of ML or AI or future iterations of these technologies and techniques not yet known can be relevant to or used with embodiments of this disclosure, particularly given the rapid pace of advancement of AI and ML at this time and the foundational understanding those of ordinary skill in the art will have with respect to these techniques as they evolve.

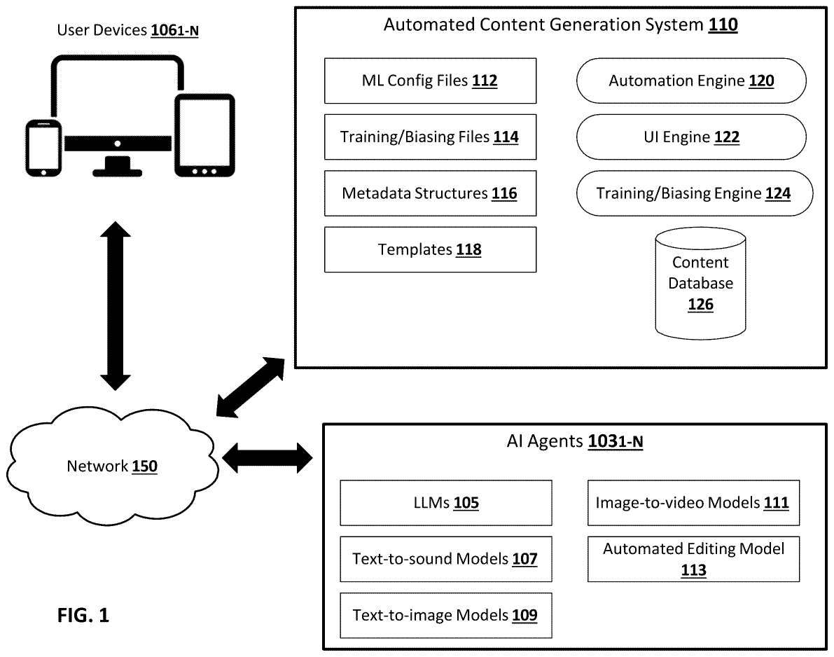

FIG. 1 depicts an example environment in which techniques disclosed herein may be implemented. The example environment includes one or more user devices 106_{1-N}, automated content generation system 110, and AI Agents 103_{1-N}. Each user device 106_{1-N} may provide a respective user interface (UI) for interacting with automated content generation system 110. Automated content generation system 110 may include one or more hardware processors or processing circuitry, and one or more memory storage devices including instructions that, when executed by the one or more processors, cause the one or more processors to perform the operations described herein.

Automated content generation system 110 can have virtually any suitable form, such as mainframe, mini, micro, super, server, or any combination of these or other types of computer systems. Moreover, automated content generation system 110 can be virtual, cloud-based, or physical. For example, one or more components of automated content generation system 110, such as one or more software engines or modules of automated content generation system 110, may be implemented on one or more computing systems (e.g., a “cloud” computing system) that are communicatively coupled to user devices 106_{1-N} and AI Agents 103_{1-N} via one or more local and/or wide area networks (e.g., the internet) indicated generally at 150.

The one or more user devices 106_{1-N} may include, for example, a desktop computer, laptop, smart phone, smart TV, tablet, smart watch or other wearable device, or other device or systems. The one or more user devices 106_{1-N} may be any type of client computing device, for example, a client computing device executing a browser application or other application configured to communicate with automated content generation system 110 via one or more local and/or wide area networks (e.g., the internet) indicated generally as network 150. The one or more user devices 106_{1-N} may each include a display device and/or one or more other input and output devices (e.g., touchscreen, mouse, etc.) that enable a user to view media content and provide user selections or other user inputs as described herein. While only three user devices 106_{1-N} are shown, automated content generation system 110 can support a large number of concurrent sessions with many user devices 106_{1-N}.

AI Agents 103_{1-N} include various machine learning models configured to perform specific tasks. For example, AI Agents 103_{1-N} include LLMs 105 that process and generate natural language text, text-to-sound models 107 that convert textual descriptions into audio outputs, text-to-image models 109 that generate visual representations based on text descriptions, image-to-video models 111 that transform static images into dynamic video sequences, and automated editing models 133 that refine and assemble generated multimedia assets into cohesive final outputs. Automated content generation system 110 may communicate with AI Agents 103_{1-N} via network 150, for example via one or more application programming interfaces (APIs). Although AI Agents 103_{1-N} are depicted as being separate from automated content generation system 110, in some implementations, one or more of the AI Agents 103_{1-N} may be included in the automated content generation system 110, for example as a part of one or more software engines or modules. In some implementations, one or more of the software engines 120-124 of the automated content generation system 110 may include one or more other AI models, such as LLMs, computer vision models, and/or Low Rank Adaptation (LoRA) models. Moreover, in some implementations, AI Agents 103_{1-N} may include one or more additional types of AI agents (not depicted) that perform one or more of the processes described herein.

Automated content generation system 110 includes software engines or modules, such as automation engine 120, UI engine 122, and training/biasing engine124, as well as one or more databases that include ML configuration files 112, training/biasing files 114, metadata structures 116, templates 118, and content database 126. In some implementations, the one or more databases that include ML configuration files 112, training/biasing files 114, metadata structures 116, templates 118, and content database 126 may be separate from, but accessible by, automated content generation system 110.

ML configuration files 112 may include configuration files associated with AI Agents 103_{1-N}. For example, ML configuration files 112 may include indications of input and output formats, model parameters, and indications of benchmark criteria for evaluating outputs associated with each of the AI Agents 103_{1-N}. Training/biasing files 114 may include data sets and parameters used to tailor the AI Agents 103_{1-N} to specific use cases or domains. For example, training/biasing files 114 may include labeled training data, weighting parameters and domain-specific rules to guide the behavior of the AI Agents 103_{1-N} during content generation. Metadata structures 116 include data structures for maintaining narrative and visual consistency throughout the content generation process. Metadata structures 116 may include information such as tags, categories, timing information, character and object descriptions, and an overarching narrative framework for the content to be generated. Metadata structures 116 may further include indexing data that enables the system to identify relevant templates, content assets, AI Agents 103_{1-N}, or automated workflows during the content generation process. Templates 118 include predefined structural and stylistic blueprints for generating multimedia content. Templates 118 may define layouts, transitions, visual effects, settings, story parameters, and/or one or more characters or objects to be included in associated content. For example, a particular template included in templates 118 may define a story about a child who joins the school basketball team and deals with bullying, and may include general indications of a main character, a bully character, a school gym, a basketball, a basketball hoop, actions the characters are to take, and emotions that the characters are to display. Content database 126 includes generated multimedia content such as videos representing episodes of one or more shows, as well as raw content assets such as video clips, audio clips, images, and text snippets. The automated content generation system 110 may generate the ML configuration files 112, the training/biasing files 114, the metadata structures 116, the templates 118, and the content included in the content database 126 based on the outputs of the AI Agents 103_{1-N}.

Automation engine 120, UI engine 122, and training/biasing engine 124 each include relevant data files and executable software for implementing the techniques described herein. UI engine 122 enables users of user devices 106_{1-N} to interact with automated content generation system 110. Automation engine 120 generates, monitors, and modifies automated content generation workflows. Training/biasing engine 124 generates or otherwise obtains training data and biasing protocols for AI Agents 103_{1-N}, stores the training data and biasing protocols in training/biasing files 114, uses the training data to train specific AI Agents 103_{1-N} to perform context-specific tasks, and uses the biasing protocols to bias the outputs of specific AI Agents 103_{1-N} to align with requirements of specific automated workflows and/or user preferences.

UI engine 122 provides outputs generated by AI Agents 103_{1-N} and/or by automation engine 120 or training/biasing engine 124 to user devices 106_{1-N}. Moreover, UI engine 122 provides the user interface for automated content generation system 110, receives user selections and other user inputs that users of user devices 106_{1-N} provide to the user interfaces, and updates the other software engines 120, 124 and the databases and files 112-118, 126 based on the received user selections or other user inputs. For example, UI engine 122 may cause one of the user devices 106_{1-N} to display two video content previews along with a prompt for a user to select which preview they prefer. In such an example, UI engine 122 may then provide an indication of which preview the user indicated they prefer to automation engine 120 or training/biasing engine 124. In some implementations, UI engine 122 may also update user preferences of a user account associated with a user that provided particular selections or other inputs, and may further update the other software modules 120, 124 and the databases and files 112-118, 126 based on the user preferences. For example, if a user indicates that they only speak Spanish, then UI engine 122 may update relevant user preferences and ensure all future prompts to automation engine 120 for content generation that are associated with the same user account include the indication that the generated content should be in Spanish.

Automation engine 120 generates, monitors, and modifies automated content generation workflows that are responsive to user requests for content generation. Automation engine 120 generates an automated workflow when UI engine 122 provides automation engine 120 with an indication of a user request for content generation that includes at least one user selection or other user input indicating the type of content to be generated. In response to receiving this user request for content generation, automation engine 120 selects one or more relevant templates from templates 118 and determines which AI Agents 103_{1-N} to use in the automated workflow based on the selected template(s) and the parameters of the user request. For example, if a user requests a story about bullying, automation engine 120 may identify the aforementioned template 118 associated with a story about a child who joins the school basketball team and deals with bullying. Automation engine 120 may then use that template 118 to determine at least some general parameters about narrative, visual, and audible content that should be generated—e.g., characters, objects, settings, dialog, music, etc. that will need to be generated. Using the determined general parameters about the narrative, visual, and audible content that should be generated based on the user request and the template, automation engine 120 may then use ML configuration files 112, and in some cases training/biasing files 114, to determine which AI Agents 103_{1-N} can be used in which order to fulfill the user request for content generation. For example, automation engine 120 may select a particular LLM 105, a particular text-to-image model 109, and a particular image-to-video model 111 to perform a sequence of data transformations from text to image to video.

In some implementations, automation engine 120 may act as an input adaptation layer between layers of AI Agents 103_{1-N} used in a given workflow. For example, automation engine 120 may process image data output by an upstream AI Agent 103_{1-N} using one or more computer vision models to generate a text-based input for a downstream AI Agent 103_{1-N}. Automation engine 120 may use the ML configuration files 112 to act as the input adaptation layer between each of the AI Agents 103_{1-N} used in the workflow. For example, automation engine 120 may identify points during a given workflow to perform input adaptation based on determining that the ML configuration files 112 indicate an output format of an upstream AI Agent 103_{1-N} does not correspond to an input format of a downstream AI Agent 103_{1-N}. Moreover, in some implementations, automation engine 120 may replace terms or parameters in outputs generated by one of the AI Agents 103_{1-N} with metadata tags from an associated one of the metadata structures 116 before providing the modified output as input to a next AI Agent 103_{1-N} in the automated workflow in order to maintain consistency (e.g., replace varied visual descriptions of a main character with an embedded reference $MainChar that is associated with a specific character description).

Automation engine 120 may monitor the outputs and performance of each of the AI Agents 103_{1-N} used during one or more sequences of processes in the generated automated workflow. Automation engine 120 may also modify an automated workflow before, during, or after it is performed based on the monitoring. For example, in response to automation engine 120 determining there is some discrepancy or inconsistency between a given output and another given output, metadata stored in an associated metadata structure 116, and/or benchmark criteria, automation engine 120 may replace a given AI Agent 103_{1-N} with another AI Agent 103_{1-N}, generate an additional or modified input, generate an additional content generation step, or perform training or biasing of the given AI Agent 103_{1-N} and then cause one or more processes of the automated workflow to be re-performed. For example, in response to determining that an output from a given image-to-video model includes a blonde main character while the metadata structure 116 associated with the automated workflow indicates a main character with black hair, automation engine 120 may replace an underperforming LLM 105 with used in an upstream text content generation process with a different LLM 105, or add in another text transformation step using the different LLM 105, and then cause a given sequence of text to image to video transformations to be performed again.

In some implementations, automation engine 120 may perform the monitoring using one or more other AI Agents 103_{1-N} not used in a given workflow or using one or more other AI models available to automation engine 120. For example, AI Agents 103_{1-N} may further include one or more video-to-text models (not depicted) that automation engine 120 uses to analyze consistency across generated visual assets. As another example, automation engine 120 may include one or more computer vision models and one or more LLMs that automation engine 120 may use to detect discrepancies between outputs and/or detect deficiencies in an output based on system benchmark criteria.

In some implementations, automation engine 120 may validate the performance of a newly included AI Agent 103_{1-N}, modified input/output, or modified sequence of content generation processes before completing the automated workflow. For example, automation engine 120 may compare an output generated using a new AI Agent 103_{1-N}, or an output generated by another AI Agent 103_{1-N} downstream from the new AI Agent 103_{1-N} to previously generated outputs, an associated metadata structure 116, and/or benchmark criteria. If a new AI Agent 103_{1-N}, modified input/output, new sequence of steps, or other modification to the automated workflow does not provide a desired improvement, then automation engine 120 may revert to the previous setup and/or select a different AI Agent 103_{1-N} or content generation step to modify. In some cases, automation engine 120 may further request that training/biasing engine 124 train or bias a given model to improve its performance and may validate that its performance improved in a similar manner as described above. In some implementations, to validate performance, automation engine 120 may request that UI engine 122 provide one or more user devices 106_{1-N} with content previews that correspond to a previous output and a current output along with a prompt for the user to select which they prefer or to otherwise provide feedback on the content previews. In such implementations, in response to UI engine 122 providing the user's selections or feedback responsive to the prompt and previews, automation engine 120 can determine whether performance of the new AI Agent 103_{1-N}, input/output, content generation step, or other modification can be validated.

Training/biasing engine 124 generates (or otherwise obtains) training data and/or biasing data and uses the training and/or biasing data to train and/or bias one or more of the AI Agents 103_{1-N}. Training/biasing engine 124 may generate the training or biasing data based on any kind of data generated by automation engine 120 in association with a given automated workflow. Training/biasing engine 124 may also generate the training or biasing data based on particular templates 118, ML configuration files 112, metadata structures 116, user selections/input/feedback, and benchmark criteria. For example, if a user provides a photo of themselves and requests that the main character associated with a particular template 118 look like them, UI engine 122 will provide the reference image to training/biasing engine 124 to generate training data (e.g., using a Low-Rank Adaptation (LoRA) model) that training/biasing engine 124 will use to train the text-to-image models 109 that will generate images of the main character. As another example, if automation engine 120 generates an automated workflow that includes a particular LLM 105 generating an output that is applied as an input to a particular downstream text-to-sound model 107, training/biasing engine 124 may generate biasing data (e.g., using a separate LLM) that may be used to bias the particular LLM 105 to provide its output in a format that is more compatible with the input format of the particular downstream text-to-sound model 107 (e.g., bias the particular LLM 105 to provide output that includes terms that correspond to music genres or character voices and/or to exclude terms that do not map to any sound characteristics). As yet another example, if a user indicates that they prefer a first content preview to a second content preview, training/biasing engine 124 may generate training or biasing data that can be used to train or bias one or more of the AI Agents 103_{1-N} or other AI models available to the automated content generation system 110 to generate output more consistent with user preferences determined based on the first content preview.

With this foundation, various features and embodiments will now be discussed. These include an automated multi-stage content generation pipeline, consistency maintenance mechanisms across multiple AI modules, custom prompt generation and transformation agents, an automated feedback loop for continuous improvement, dynamic integration and modularity of third-party AI models, structured data representations for multi-layered content creation, and user-prompted personalized content generation, among others. Any one of these features may comprise stand-alone systems or methods, unless otherwise stated, that can include, work with, or be complemented by AI, such as ML. Furthermore, various ones of these features may be combined into other systems or methods; used sequentially or in parallel; or otherwise combined in ways that will be apparent to those having skill in the art.

### Automated Multi-Stage Content Generation Pipeline

In some embodiments, a multi-stage pipeline can be used in an automated workflow to transform a single user prompt into a complete multimedia content piece. This system or method enables users to create new custom content tailored to their own preferences without requiring significant manual intervention for content curation, editing, and personalization. Thus, users can use automated multi-stage content generation pipelines to generate tailored, context-sensitive multimedia content regardless of technical expertise or skill level. In one embodiment, users can enter a text prompt that is provided to a content generation pipeline that includes one or more sequences of AI models to generate a multimedia content item. In some embodiments, the automated multi-stage content generation pipelines can be used to create groups of content (such as episodes, series, spin-off series, etc.).

In some implementations, the system may generate the automated multi-stage content generation pipeline to perform a particular automated workflow based on determining one or more sequences of AI models and/or corresponding content generation steps to transform the text prompt of the user into the multilayered multimedia content. The system may access a database of ML configuration files indicating input/output formats and performance data associated with a plurality of AI models that the system may use to select all or a subset of the AI models for inclusion in the automated multi-stage content generation pipeline. Thus, for example, the system may select the AI models to use in the pipeline in such a way as to balance the needs of the user request with considerations of resource usage, speed, accuracy, likelihood of a pipeline needing modification during the automated workflow, etc. Then, based on the selected AI models, the system may determine the sequence of content generation steps that the pipeline should perform during the automated workflow. Additionally or alternatively, in some implementations, the system may determine the sequence of transformations that data must go through in the pipeline to generate the multi-layered multimedia content, and then the system may select the AI models that correspond to the sequence of transformations (e.g., an LLM upstream of a text-to-image model for a sequence that includes text generation then image generation). Moreover, in some implementations, the structure (e.g., order and flow) of the automated multi-stage content generation pipelines may also be determined using one or more AI models.

In some implementations, generating the automated multi-stage content generation pipeline may further include generating model biasing protocols for the AI models selected for use in the automated multi-stage content generation pipeline. In some implementations, based on the information included in the ML configuration files, the system may generate model biasing protocols for some or all of the AI models to be included in the automated multi-stage content generation pipeline in order to ensure that the output formats of upstream AI models are compatible with the input formats of downstream AI models. For example, an upstream LLM may be biased to provide output in a format that clearly maps descriptions to photography, cinematography, and/or animation terminology (e.g., “camera angle: eye-level”, “lighting: gentle spotlight with a blue gel”, etc.), thus ensuring that output is optimized for being provided as an input to a downstream text-to-image model.

In some implementations, the system may access a database of training/biasing files that were generated during previous automated workflows associated with other automated multi-stage content generation pipelines and then train and/or bias the AI models selected for the instant automated multi-stage content generation pipeline. For example, if the user requests video content corresponding to an animated cartoon, the system may select training and/or biasing files that were previously used during automated workflows that generated animated cartoons and then use those training and/or biasing files to train and/or bias the AI models of the instant automated multi-stage content generation pipeline in order to tailor the pipeline to the user's request.

An exemplary implementation is provided below for the automated multi-stage content generation pipeline, along with select user interfaces:

The user initiates the generation of multimedia content by providing a high-level thematic or narrative prompt. For example, a user may provide a prompt such as “a story about two curious kids who discover a magical forest while learning about teamwork.” An LLM analyzes the user prompt to develop a creative story concept. This includes defining plot arcs, character dynamics, and themes. The output of the LLM will thus indicate a narrative framework specifying key story elements.

Next, the story concept is expanded into a detailed, multi-scene script using a specialized LLM (e.g., biased to provide a script as a formatted table). The script may include, for example, dialogue that reflects the characters'personalities and drives the narrative forward, narration to establish context or transitions, and scene descriptions that set the tone and setting. In some implementations, prior to generating the script, the system may select one or more content templates, from a database of templates, to use to generate the script. For example, if a user requests content about “a child being bullied”, the system may select one or more templates that best match the user request. The selected template(s) may indicate features such as characters, objects, settings, and contexts. The selected template(s) may be provided as additional input(s) to the LLM that generates the script or may be used to generate training or biasing data to train or bias the LLM that generates the script to generate the script based on the selected template(s).

One or more software engines, software modules, or AI models (e.g., another LLM) are then used to parse the script and generate a metadata structure using predefined rules (e.g., from a biasing protocol), wherein each entry of the generated metadata structure may correspond to a particular scene, character, setting, object, and/or camera angle. The metadata structure is generated to optimize the representation of the script for downstream asset creation. For example, while the generated script might describe a character's physical appearance in different ways at different points in the script, the generated metadata structure may include embedded references $Character or other trigger words that are associated with a particular entry in the metadata structure that maintains a consistent physical description for the character. Thus, during downstream content generation processes in the pipeline, one or more downstream AI models can receive a consistent character description even when they are generating content for different scenes. The metadata structure therefore acts as a reference table of sorts, with the entries of the reference table including reference data for use during downstream content generation processes in the pipeline. The reference data generated for the metadata structure may include visual content generation parameters (e.g., visual descriptions of characters, objects, movements, and settings), audible content generation parameters (e.g., character speaking lines, sound effects, etc.), and the narrative framework of the script (e.g., how the scenes fit together). In some implementations, the reference data in the metadata structure will only include text content. In other implementations, the reference data may also include image data and/or pointers to image data.

Once the initial set of AI models transforms the user prompt into the metadata structure optimized for downstream asset creation, the pipeline proceeds to generate the visual assets and audio assets that will be combined to create the multi-layered content responsive to the user request.

To generate visual assets, inputs associated with visual descriptions are retrieved from the metadata structure and applied to one or more text-to-image models. The text-to-image models generate reference image data to be used in one or more downstream content generation processes based on the visual descriptions from the metadata structure. For example, visual descriptions for each character, object, action, story arc, and/or scene may be used to generate reference image data for each character, object, action, story arc, and/or scene. Downstream image-to-video models are then used to generate video clips by adding movement and combining instances of the reference image data. For example, reference image data of a child holding a ball, throwing the ball, and then looking into the stands may be applied as input to an image-to-video model that generates a video clip of the child dribbling the ball, throwing the ball with standard layup form, and then turning to look into the stands to their right. Each video clip generated may correspond to a particular scene or portion of a particular scene.

To generate audio assets, inputs associated with audio descriptions are retrieved from the metadata structure and applied to one or more text-to-sound models. The text-to-sound models generate corresponding audio clips that contain speech, sound effects, and/or music audio. For example, audio descriptions for each spoken line may be used to generate audio clips including particular voices speaking particular words. As another example, visual and narrative descriptions included in the metadata structure that correspond to audio descriptions (e.g., “waves crash peacefully against the rocks on the beach”) may be used to generate audio clips corresponding to sound effects (e.g., the sound of the waves crashing) as well as background music (e.g., peaceful instrumental music that fits the narrative “vibe” of “waves crash peacefully against the rocks on the beach”).

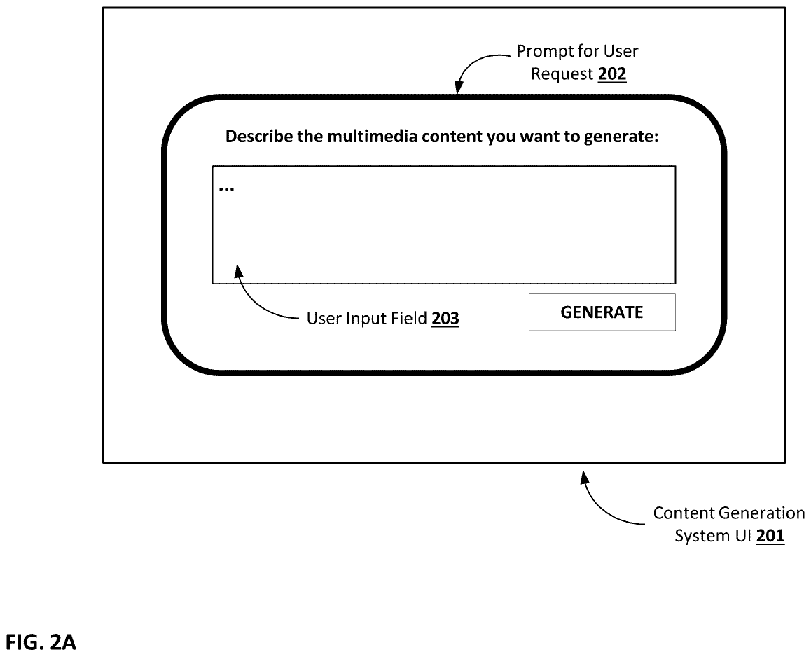

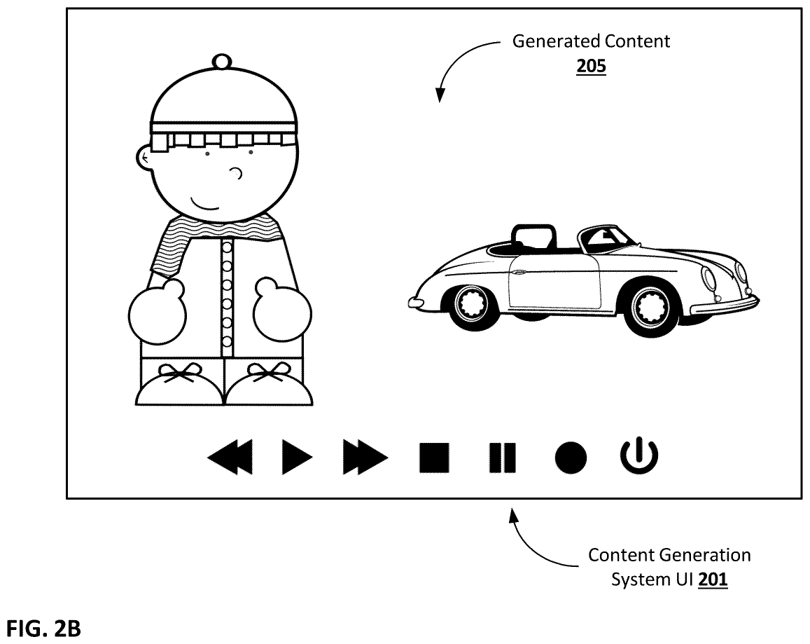

Once the visual assets and audio assets have been generated, they are applied as inputs to one or more AI models trained to generate the final multimedia content piece by synchronizing the visual and audio assets based on timing information extracted from the metadata structure (e.g., by scene). In some implementations, generating the final multimedia content piece by synchronizing the visual and audio assets further includes generating content labels for the visual and audio assets that indicate a relative position within a content timeline indicated by the script. The final multimedia content piece is then provided to the user on the user device that provided the user prompt for content generation. Thus, from the user's view, they will provide a text prompt on a first UI and, in response, a second UI will appear with their final multimedia content piece ready for review. FIGS. 2A-2B depict example user interfaces for the first UI and second UI of the automated content generation system, respectively. As shown in FIG. 2A (e.g., the first UI), the content generation system UI 201 of the automated content generation system includes a prompt for a user request for content generation 202 and a user input field 203 where the user can provide their content generation request. After the user has provided their content generation request to the automated content generation system, the content generation system UI 201 updates, as depicted in FIG. 2B (e.g., corresponding to the second UI), to display the generated content 205.

During performance of the automated workflow resulting from this multi-stage content generation pipeline, one or more software engines, software modules, or AI models will be used to monitor each output of the pipeline. This monitoring includes comparing the outputs to each other, associated information in the metadata structure, and/or benchmark criteria in order to monitor the performance of the automated workflow. In some cases, based on the monitoring, one or more software engines, software modules, or AI models not included in the pipeline may generate a biasing protocol for at least one of the AI models that is included in the pipeline. For example, if a downstream text-to-image is producing subpar or inconsistent outputs, a biasing protocol for the upstream LLM that generates the input to the downstream text-to-image model may be generated such that the biasing protocol causes the upstream LLM to produce output that includes more photography-related terms (e.g., to include “close up on X character” or a specific camera distance). When such a change is made, the automated workflow may cause a content generation process or a sequence of content generation processes to be re-performed. For example, after biasing the upstream LLM to include more photography-related terms in its output, the input provided to that LLM pre-biasing may be applied again, thus causing that upstream LLM to generate a new and improved input for the downstream text-to-image model, and then the reference image generation steps associated with that downstream text-to-image model may also be performed again.

### Consistency Maintenance Mechanism Across Multiple AI Modules

In some embodiments, a consistency maintenance mechanism can be generated and then used during an automated workflow that uses multiple AI modules for generating multimedia content to maintain narrative and visual consistency across multiple stages of the workflow. This system or method enables content creation platforms to automatically generate coherent multimedia content from a simple user prompt without requiring the user to provide additional inputs. This system or method thus enables multi-stage multimedia content generation workflows to require less computing resources, time, and/or user inputs compared to systems or methods in which the user is charged with noticing artifacts, inconsistencies, or other deficiencies in the generated content and then re-initiating performance of one or more content generation steps in order to fix the deficiencies.

An exemplary implementation is provided below for the consistency maintenance mechanism across multiple AI modules:

The user requests performance of a multi-stage multimedia content generation workflow by providing a high-level thematic or narrative prompt to the system, as described elsewhere herein. For example, a user may provide a prompt such as “a story about a robot exploring space.” In response to the user prompt, the system generates the multi-stage multimedia content generation workflow by determining which content generation processes to perform and which AI models to use at each stage of the workflow. For example, based on accessing a database of ML configuration files defining input and output formats (e.g., content types) for the AI models, the system may generate the multi-stage multimedia content generation workflow to correspond to an order of usage for a particular set of AI models that causes each subsequent stage or AI model to accept inputs in a format that corresponds to an output format of a preceding stage or AI model. In some implementations, the system may determine one or more predefined templates, from a database of templates, that most closely match the user prompt. In such implementations, the system may further determine which AI models to use and the order to use them in during the workflow based on determined template(s) (e.g., based on data transformations and AI models used during other workflows associated with those template(s)).

Once the multi-stage multimedia content generation workflow has been generated, the system may generate a dynamic reference table that can be used as a consistency maintenance mechanism across multiple stages/AI models during the content generation processes the AI models perform in the multi-stage multimedia content generation workflow. The system processes the user prompt and/or predefined template(s) using one or more AI models during the first stage of the multi-stage multimedia content generation workflow in order to generate reference data for the dynamic reference table that can be used to ensure uniformity across downstream processes of the workflow. The generated dynamic reference table may include a plurality of entries that each include reference data for visual or audible asset generation and that each correspond to at least one AI model of the workflow. In some implementations, one or more entries of the dynamic reference table may be generated to include embedded references to content generation parameters such as character traits, key objects, and scene settings. The embedded references may be data elements that encode references to one or more other entries in the dynamic reference table that maintain consistent descriptions or other parameters.

Once the dynamic reference table has been generated, the system performs a plurality of content generation processes in accordance with the order and flow outlined by the multi-stage multimedia content generation workflow. During performance of the content generation processes of the workflow, the system updates the dynamic reference table to include or indicate generated outputs, such as updated reference data, pointers to reference images or other reference files, and pointers to raw content assets (e.g., video clips and audio clips). The outputs generated during each of the content generation processes of the workflow are generated by the AI models based on input reference data obtained from corresponding entries in the dynamic reference table.

In some implementations, one or more of the AI models associated with a current or next stage in the workflow may compare a given input or output to one or more other outputs generated during the workflow, to one or more benchmark criteria determined based on viewing metrics associated with other video content, and/or to the reference data of the dynamic reference table in order to detect deficiencies. For example, the system may determine that an output video clip is deficient because it does not match visual description reference data in the dynamic reference table and/or because it does not satisfy predefined pacing requirements. As another example, the system may compare two video clips and determine one or both of them are deficient based on processing the video clips using one or more computer vision models and comparing the outputs of the computer vision model(s) to one another and/or to reference data included in the dynamic reference table.

In some implementations, the system may use one or more of the AI models to generate new or updated reference data to replace or supplement the reference data in the dynamic reference table that is associated with generating the deficient output. For example, if a video clip is determined to be deficient because it does not meet predefined pacing requirements, the system may identify a particular entry in the dynamic reference table that corresponds to the input that an AI model used to generate the video sequence. In such an example, the system may then generate new or updated reference data associated with generating a more fast-paced scene and store this updated reference data in the particular entry or in another particular entry associated with an upstream content generation process (e.g., update an entry associated with the LLM that generated the prompt to the text-to-image model that generated the reference images used by the image-to-video model as well as pacing metadata that influences asset assembly in a timeline). In some implementations, the system may select a particular entry from the dynamic reference table to update based on determining that the particular entry is associated with one or more particular AI models that provided intermediary output(s) used to generate an input to a different, downstream AI model in the workflow that provided the output(s) that were determined to be deficient. For example, the system may determine to update an entry that defines the descriptions or parameters of an embedded reference that is included in one or more other entries. In such an example, based on updating the entry that defines an embedded reference, multiple other entries that embedded reference may also be updated (e.g., current/downstream entries or all entries with that embedded reference).

In response to the system detecting a deficiency in an output and updating an entry of the dynamic reference table by replacing or supplementing previously generated reference data with new or updated reference data, the system will then cause any outputs that were generated during processes downstream from a point associated with the updated entry in the dynamic reference table to be re-generated. Thus, for example, if the system detects a deficient video clip, generates updated reference data to modify the pacing, and stores it in an entry associated with the LLM that generated the prompt to the text-to-image model that generated the reference images used by the image-to-video model, then the system will then cause the LLM to re-generate the prompt using the updated reference data, cause the text-to-image model to re-generate the reference images based on the re-generated prompt, and then cause the image-to-video model that initially generated the deficient video clip to re-generate a new video clip based on the re-generated reference images.

In some implementations, the system may generate multiple instances of updated reference data and use them in performing multiple instances of a given workflow. In such implementations, performance of the multiple instances of the given workflow may result in generation of multiple instances of final multimedia content and the system may cause a user device of the user to display more than one of the multiple instances of final multimedia content along with a prompt for the user to select which instance of final multimedia content they prefer. In some such implementations, the system may generate training data based on the particular instance of final multimedia content the user selects in response to the prompt. The system may use the generated training data to train one or more of: the particular AI model that corresponds to the updated entry, and the AI model(s) that detected the deficient outputs.

Once all visual and audio assets have been generated based on the dynamic reference table, the system uses one or more AI models trained to synchronize the video clips and audio clips to create the final piece of multimedia content. In cases where a deficient output caused the system to update the dynamic reference table and re-generate one or more assets, the final piece of multimedia content may be generated to include the re-generated assets but exclude any of the previously generated assets that were re-generated to cure the deficiency. In some implementations, the system may process the final piece of multimedia content using one or more additional machine learning models (e.g., a computer vision model) trained to detect inconsistencies or discrepancies in synchronized video content. In such implementations, if the system detects an inconsistency or discrepancy in the final piece of multimedia content, the updating and re-generating processes may be performed similarly as described above to re-generate a new final piece of multimedia content that does not include the detected inconsistency or discrepancy.

The final multimedia content piece is then provided to the user on the user device that provided the user prompt for content generation. Thus, from the user's view, they will provide a text prompt on a first UI and, in response, a second UI will appear with their final, coherent multimedia content piece that is free from any artifacts, inconsistencies, or other deficiencies that would have otherwise made their way into the final multimedia content piece.

### Custom Prompt Generation and Transformation Agents

Some embodiments of the instant invention include systems and methods for customizing prompt generation processes using transformation AI agents transforming. AI agents are customized AI models that have been biased to perform certain tasks in a context-sensitive manner. Transformation AI agents are AI models that have been biased to accept inputs in a format corresponding to an upstream AI model and to provide outputs in a format corresponding to a downstream AI model. Thus, transformation agents can be used to customize the prompt generation processes during an automated content generation workflow in order to optimize the inputs to downstream AI models of the workflow. For example, one may bias a given LLM to be a script generator using a detailed system prompt that instructs the LLM to transform narrative text inputs (e.g., generated by an upstream script-generation LLM) into outputs in a format tailored to a downstream text-to-image model (e.g., transforming “the scene opens on $MainChar sitting on the beach” into “camera angle: close up on $MainChar; setting: New England beach; lighting: full daylight”).

By customizing the prompt generation processes using transformation AI agents, the systems and methods described herein can optimize the inputs to downstream AI models during an automated content generation workflow. This allows the system to produce high quality multimedia content even when using user inputs and AI models that may not be perfectly suited to a given content generation task (e.g., user prompts that include/exclude certain details, off-the-shelf AI models, etc.), thus saving users from having to perform the same level of troubleshooting or editing that they would need to in a system that lacks such an input optimization mechanism.

An exemplary implementation is provided below for the custom prompt generation and transformation agents:

The user initiates the generation of multimedia content by providing a high-level thematic or narrative prompt. For example, a user may provide a prompt such as “a story about a hero avenging the death of his father.” An LLM analyzes the user prompt to develop a script. The script may include, for example, dialogue that reflects the characters'personalities and drives the narrative forward, narration to establish context or transitions, and scene descriptions that set the tone and setting.

Once the script generated responsive to the user prompt has been obtained, the system determines a set of AI models and corresponding content generation parameters to be used during a sequence of content generation processes. The system may determine the set of AI models as described elsewhere herein. For example, the system may select the AI models based on accessing a database of ML configuration files that specify input and output formats for the AI models. The system may generate the corresponding content generation parameters based on analyzing the script (e.g., using one or more LLMs) to identify specific details required for each of the AI models, such as scene context (e.g., urban, natural, fantastical settings), character attributes, emotional tone, key objects, and key interactions between characters and/or objects. For example, the system may generate certain visual content generation parameters tailored to the input format of a specific AI model that is to be used to generate character reference images.

The system generates a plurality of system prompts for biasing the set of AI models to cause the AI models to further act as transformation AI agents. In some implementations, the system may generate the system prompts based on accessing a database of ML configuration files that define capabilities and input/output formats associated with each of the AI models. Additionally or alternatively, in some implementations, the system may generate the system prompts based on accessing a database of training data and biasing files that were previously generated for the AI models during performance of other workflows (e.g., other workflows including one or more of the same AI models and/or other AI model(s) performing similar data transformations). The plurality of system prompts are generated such that each of the AI models, once biased, will accept inputs in a format corresponding to a previous content generation process in the sequence of content generation processes and/or will provide outputs in a format corresponding to a subsequent content generation process in the sequence. The system then uses the generated plurality of system prompts to bias the set of AI models to create customized AI agents, at least a portion of which will be the transformation AI agents capable of optimizing prompts or other inputs to each next content generation process in the sequence.

The system performs the sequence of content generation processes by applying the content generation parameters as inputs to the corresponding customized AI agents. Performing the sequence of content generation processes includes generating: text content using one or more first AI agents; a reference table (including visual reference data and audible reference data) based on the generated text content using one or more second AI agents; video clips based on the visual reference data using one or more third AI agents; audio clips based on the audible reference data, the visual reference data, and the text content using one or more fourth AI agents; and the final multimedia content piece based on the video clips, the audio clips, and the reference table using one or more other AI agents. The final multimedia content piece is then provided to the user on the user device that provided the user prompt for content generation.

In some implementations, generating the audio clips based on the audible reference data, the visual reference data, and the text content using one or more fourth AI agents may include generating different audio clips using different AI agents and inputs. For example, the system may generate a first portion of the audio clips based on applying inputs generated based on the audible reference data and the visual reference data to a text-to-speech model that generates audio clips that include narrator and character speech. In such an example, the system may generate a second portion of the audio clips based on applying inputs generated based on the audible reference data, the visual reference data, and the text content to a text-to-music model that generates background music. In some such implementations, the inputs to the text-to-speech model and the inputs to the text-to-music model may be generated by different AI agent (e.g., one biased to generate inputs tailored to the text-to-speech model and another biased to generate inputs tailored to the text-to-music model).

In some implementations, the one or more third AI agents used to generate the video clips based on the visual reference data may include at least one text-to-image model and at least one image-to-video model. In some such implementations, generating the video clips based on the visual reference data using one or more third AI agents may include generating training data for the text-to-image model(s) based on a first portion of the visual reference data and training the text-to-image model(s) using the training data. The system may then use the trained text-to-image model(s) to generate reference image data based on applying a second portion of the visual reference data as input to the trained text-to-image model(s). The system may generate video generation prompts based on a third portion of the visual reference data (e.g., using an additional LLM), and then generate the video clips based on applying the reference image data to the video generation prompts as inputs to at least one image-to-video model. For example, a user may provide an image of their child with their user request to “generate a video about bullying where my daughter is the main character.” In such an example, the system may generate visual reference data that includes a pointer to the image of the user's child, character traits associated with a main character of a story (e.g., defined by a template), descriptions of key objects and settings that the characters interact with, and descriptions of character and object movements. The system may generate the training data for the text-to-image model(s) based on merging character traits with traits determined based on the image of the user's child (e.g., using a computer vision model and a Low-Rank Adaptation (LoRA) of a foundational image generation model (ex. Stable Diffusion). The system may use the training data to train one or more layers of the text-to-image model(s) to encode reference-specific adjustments associated with the merged character traits. The system may generate reference image data (e.g., capturing the user's daughter as the main character) based on applying the character traits, descriptions of key objects, and descriptions of settings included in the visual reference data as inputs to the trained text-to-image model. The system may generate video generation prompts based on at least the descriptions of character and object movements included in the visual reference data. The system may then generate the video clips based on applying the reference image data and the video generation prompts as inputs to the image-to-video model(s).

During performance of the sequence of content generation processes, the system monitors the outputs generated by each of the AI agents for discrepancies between the outputs of the AI agents associated with a current content generation process and the input formats associated with subsequent content generation processes (e.g., using computer vision models and LLMs). If a discrepancy is detected, for example when an LLM generates text content that does not match the input structure or terminology required by a text-to-image model, then the system uses corresponding transformation AI agents to transform the deficient outputs into modified inputs that are in a format consistent with the requirements of a given AI agent associated with the subsequent content generation process.

In some implementations, the system will generate the modified input using one or more of the AI models that detected the discrepancy. For example, a computer vision model may translate image data into text data that an LLM cross-references with content generation parameters of an associated reference table, and the LLM may generate the modified input based on the comparison and the detected discrepancies or deficiencies. In some implementations, the system will generate the modified input using a different AI model from the AI model that detected the discrepancy. For example, the system may compare the outputs of a computer vision model that processed two video clips to one another, and then the system may use an LLM to generate the modified input based on the comparison of the outputs. In some implementations, the system may select a particular AI model to generate the modified input based on the type of discrepancy detected. For example, the system may select a scriptwriting AI agent to generate the modified input based on determining that there was a script-level deficiency in various outputs of a given workflow.

In some implementations, the system may generate the modified input based on generating a modified biasing protocol for an AI agent that is upstream, in the sequence of content generation processing, from the given AI agent that is to receive the modified input. For example, the system may generate a modified biasing protocol for an LLM that generates video generation prompts for a downstream text-to-image model to bias the LLM to provide outputs in a modified format. The system may bias (or re-bias) the LLM using the modified biasing protocol and then cause the LLM to re-generate its outputs (e.g., generate modified output compared to outputs generated during a previous iteration). The system may then use the modified output generated by the re-biased LLM as the modified input for the given AI agent during a subsequent content generation process in the sequence.

Once the modified input has been generated, the system causes at least a portion of the sequence of content generation processes associated with the given AI agent to be performed again based on the modified input. In some cases, the portion of the sequence of content generation processes that are performed again may only correspond to the subsequent content generation process in the sequence and any further downstream content generation processes in the sequence. In other cases, the portion of the sequence of content generation processes that are performed again may include one or more current or previous content generation processes in the sequence. For example, when it is determined that an output of a given LLM that generates image prompts is not compatible with the input requirements of a downstream text-to-image model, a modified input may be generated by a transformation AI agent for a different, upstream LLM that generates parameters used by the given LLM to generate the image prompts. In such an example, the system would cause the upstream LLM to re-generate its outputs based on the modified input, cause the given LLM to re-generate the image prompts based on the re-generated outputs, and then apply the re-generated image prompts as the inputs to the text-to-image model associated with the subsequent content generation process.

In some implementations, the system may perform a validation process to validate performance of a given AI agent using a modified input by comparing an output generated by the given AI agent based on the modified input during a particular content generation process to reference data included in the dynamic reference table (e.g., to determine if the modified input causes a deficiency). In such implementations, the system may only cause one or more other content generation processes associated with the given AI agent (e.g., downstream processes associated with the given AI agent) to be performed again if the performance of the given AI agent using the modified input can be successfully validated. In some implementations, in response to being unable to validate the performance of the given AI agent, the system may generate an updated modified input for the given AI agent for that particular content generation process, validate performance of the given AI agent using the updated modified input (e.g., using a similar validation process), and then cause at least a portion of the sequence of content generation processes associated with the given AI agent to be performed again based on the updated modified input.

In some implementations, the system may generate training data for a given AI agent based on a modified input and/or re-performance of at least a portion of a sequence of content generation processes. For example, the system may generate training or biasing data based on comparing newly generated video clips generated during a second instance of a workflow that uses the modified input to previously generated video clips generated during a first instance of the workflow that did not use the modified input. Additionally or alternatively, the system may generate the training or biasing data based on comparing one or more of the previously generated outputs that were determined to be deficient to the modified input. The system may use the generated training or biasing data to train or bias a corresponding AI model for the current workflow and/or future workflows.

In some implementations, the system may generate an additional external input instead of or in addition to generating the modified input. The system may generate the external input in a similar manner as described above for generating modified inputs. The system may apply the external input to the given AI agent in addition to the modified input, may apply the external input to the given AI agent along with the input that was previously used for that given AI agent during that particular content generation process (e.g., the original, unmodified input), or may apply the external input as an input to another AI agent associated with an upstream or downstream content generation process in the sequence of content generation processes.

### Automated Feedback Loop for Continuous Improvement

In some embodiments, an automated feedback loop can be implemented for continuous improvement of generated content and automated content generation workflows. This system or method enables refinement and optimization of future content generation parameters and automated content generation workflows. This system or method system further enables continuous enhancement of content quality and relevance.

An exemplary implementation is provided below for the automated feedback loop:

The system, by way of one or more automated content generation workflows, generates videos using corresponding metadata structure(s) (e.g., content generation reference table(s)) that include content generation parameters, as described elsewhere herein. The system generates the videos, during the workflow(s), based on video segments (e.g., video clips) that were generated during one or more preceding steps of the workflow(s). Each content generation reference table includes entries associating content generation parameters and content generation models with a corresponding sequence of content generation steps for a given automated content generation workflow.

Viewers may provide feedback to the system for the videos they view, either directly or indirectly. Viewers who view the generated videos may provide structured feedback directly in various ways. For example, the system may receive indications of user selections from user devices when users “like” or “dislike” a video, rate the video X out of Y stars, add the video to a playlist or collection, and/or add or edit descriptions or metadata tags associated with the video. In some implementations, the structured viewer feedback received by the system may further include structured feedback from human reviewers associated with a content distribution platform (e.g., from parsing moderator feedback forms). The system may also receive indirect feedback from viewers in the form of viewer engagement metrics such as watch time, drop-off rates, viewer reactions (e.g., likes, shares, comments), and heatmap analytics for viewer focus areas within videos. The system may determine incidence information for viewer engagement actions by determining particular video segments associated with the viewer engagement metrics. Thus, the viewer feedback received by the system may include both quantitative and qualitative data, and the system automatically organizes and stores this quantitative and qualitative viewer feedback data in structured formats associated with the videos for downstream analysis. For example, the system may categorize qualitative data into themes (e.g., “inconsistent character depiction,” “improve pacing”) and map the quantitative data to specific content parameters (e.g., “low engagement for Scene 10,” “high drop-off rate during transition segments”). The viewer feedback is then stored in the structured formats in a centralized feedback database.

The system uses one or more AI feedback analysis models to analyze the viewer feedback from the centralized feedback database to identify patterns in viewer behavior and preferences, common issues in content workflows or generation processes, and opportunities to enhance future outputs. The outputs of the AI feedback analysis models may indicate suggestions associated modifying the patterns of viewer behavior associated with respective videos and/or respective video segments. For example, based on processing the incidence information associated with viewer engagement actions and indications of corresponding associated video segments, an AI feedback analysis model may provide an output that indicates that “videos with slower pacing and dialogue pauses showed higher retention, suggesting the need for adjusted cadence in future scripts” or that “scenes with outdated pop culture references show higher viewer drop-off rates, suggesting the need for modification of old episodes to maintain relevance to viewers.”

The system uses the outputs of the AI feedback analysis models to generate updated content generation parameters for corresponding entries in corresponding content generation reference tables. For example, the system may provide the outputs of the AI feedback analysis models as inputs to the one or more LLMs that generated the previous corresponding content generation parameters in the corresponding content generation reference tables, and the one or more LLMs may generate the updated content generation parameters in response.

The system then stores the updated content generation parameters in the corresponding entries of the corresponding content generation reference tables. For example, an entry may be updated with content generation parameters generated to optimize pacing, dialogue flow, or story arc structures. As another example, an entry may be updated with content generation parameters generated to address visual consistency issues, better align visuals with intended aesthetics, adjust tone, add or increase audio pauses or background audio. As yet another example, an entry may be updated with content generation parameters generated to increase non-dialogue scenes to improve pacing or standardize lighting descriptions to ensure mood consistency. In some cases, the system may replace the previous content generation parameters of an entry with updated content generation parameters. For example, a previous content generation parameter of “wide shot of $Character in a forest” may be replaced with an updated content generation parameter of “wide shot of $Character in a dense forest illuminated by soft golden light.” In other cases, the system may supplement the previous content generation parameters of an entry by storing the updated content generation parameters with the previous content generation parameters in the entry. In some such cases, the updated content generation parameters may include updated prompt guidelines for LLMs that generate prompts for other AI models to use during automated content generation workflows. For example, an entry associated with a given AI model that adapts outputs of an upstream AI model to generate inputs for a downstream AI model may be updated to include directions for generating inputs that are better tailored to the downstream AI model.

The system may generate new videos using the updated content generation reference tables during performance of the corresponding sequences of content generation steps associated with the updated content generation reference tables. In some implementations, the system may perform particular content generation steps from the corresponding sequences that are associated with the updated entries in the updated content generation reference tables. In some implementations, those particular content generation steps may include not only the content generation steps associated with the entries including updated content generation parameters, but also any downstream content generation steps in the corresponding sequences. For example, the system may determine corresponding points during the sequences of content generation steps associated with particular video clips based on corresponding content generation reference tables (e.g., based on entries associated with AI models that are associated with particular content generation steps). In such an example, the system may determine downstream content generation steps based on the determined corresponding points during the corresponding sequences of generation steps associated with the respective video clips. Thus, for example, in response to an entry associated with an image generation step being updated, the system may cause not only the image generation step to be performed using the updated content generation parameters, but may also cause the video generation step and the video/audio segment synchronization step to be performed since those steps use inputs generated based on the output of the upstream image generation step.

In some implementations, the system may determine corresponding improvement scores for the new videos generated based on the updated entries. For example, the system may determine an improvement score based on a change in the percentage of viewing users who liked, shared, and/or watched a new video for at least a threshold period of time compared to the previous video that was generated from the corresponding content generation reference table before it was updated. In some implementations, the system may generate training data for at least one AI model that was used to generate the updated content generation parameters based on the updated content generation parameters and their corresponding improvement scores. The system may use this training data to train the at least one AI model. For example, the system may train a text-to-image model to generate images that more closely align with a particular animation aesthetic using training data generated based on content generation parameters that were updated to more closely align with that aesthetic and improvement scores that showed the alignment with the aesthetic led to longer watch times for viewing users.

In some implementations, the system may determine one or more particular templates, from a database of predefined templates, that were used to generate the content generation parameters associated with a previous iteration of a new video (e.g., the version generated before the content generation parameters were updated). In such implementations, the system may generate a modified version of the one or more particular templates based on the updated content generation parameters and the corresponding improvement score(s) associated with the new iteration of the video. For example, the system may update a particular template that includes indications of a particular visual aesthetic style to indicate a new particular aesthetic style based on determining that the updated content generation parameters associated with the new particular aesthetic style corresponded to high improvement score for user watch times of the new iteration of the video. In some implementations, the system may update templates that were not used to generate a given new video but that are similar or are otherwise associated with a template used to generate the given new video. For example, the system may update all templates associated with a given animation style, character (e.g., Milo the Mouse), key object (e.g., baseball), type of movement (e.g., dancing), or plot point (e.g., mom dies).

In some implementations, the system stores the feedback-derived adjustments made to the corresponding entries, content generation parameters, and/or templates as metadata in a centralized database in association with indications of corresponding videos and/or video clips. This enables the system to perform long-term tracking of iterative improvements and retrospective analysis of changes and their impacts on viewer engagement (e.g., based on new viewer feedback for the new videos). For example, using the feedback-derived adjustments of the centralized database and updated viewer feedback, the system can determine a particular iteration of content generation parameters that satisfies one or more criteria (e.g., threshold level of improvement in viewer watch times). Based on such a determination, the system can generate adjustments for content generation parameters associated with different content generation reference tables for different videos (e.g., to improve viewer watch times for a new episode of a different show in the same genre) and/or generate training or biasing data for tailoring an AI model to generate outputs that include the desired adjustments.

### Dynamic Integration and Modularity of AI Models

In some embodiments, modular content generation workflows can be implemented that enables swapping of AI models without disrupting the workflows. This system or method creates a database to track how different AI models perform during automated content generation workflows. If an AI model is not performing up to standard during a given workflow, then the system selects a different AI model, configures it for the given workflow, and then validates that the performance of the different AI model is satisfactory for the given workflow. This system or method thus uses dynamic modular integration of AI models to enable replacement of underperforming components with better suited components to ensure high-quality multimedia content generation and efficient allocation of computing resources.

An exemplary implementation is provided below for the dynamic modular integration of AI models in modular content generation workflows:

The system may generate a database of performance metrics for a plurality of AI models used during various automated content generation workflows. Each of the automated content generation workflows may use multiple AI models to generate and synchronize various raw content assets (e.g., video clips and audio clips) into a final video content piece. The system may generate the database of performance metrics based on monitoring metrics such as rendering time, cost efficiency, computational efficiency, and output quality for the plurality of AI models during the workflows.

The system may monitor the performance metrics included in the database for each AI model for each corresponding workflow in order to detect any discrepancies or deficiencies in performance for the AI models of a workflow compared to system quality benchmarks. For example, the system may determine whether visual outputs satisfy style and character consistency benchmarks, whether visual outputs satisfy transition smoothness and prompt alignment benchmarks, whether audio outputs satisfy tone/pronunciation accuracy and pacing benchmarks, etc. As another example, the system may determine whether a rendering time associated with a text-to-image model generating a particular output satisfies rendering time benchmarks. If the system determines that an output of a particular AI model does not satisfy a system quality benchmark, then the system may determine that there is a discrepancy or deficiency in performance for the particular AI model.

In response to the system detecting a discrepancy or deficiency in performance for a particular AI model in a given automated content generation workflow, the system may determine one or more alternative AI models to use in the given workflow instead of or in addition to the particular AI model associated with the discrepancy or deficiency. The system may select alternative AI models from the plurality of AI models that can be used during automated content generation workflows based on the performance metrics associated with the alternative AI model, the project requirements, and the deficiency or discrepancy to be remediated. For example, in some implementations, the system may determine resource usage requirements for a plurality of AI models that can be used for a given workflow, rank the plurality of AI models based on their resource usage requirements for the given workflow, and then select the alternative AI model from the plurality of AI models based at least in part on the ranking.

As another example, the system may select a given alternative AI model that generates high-detail outputs for a content generation step in a given workflow that is associated with generating intermediary outputs critical to downstream content generation processes (e.g., to prioritize high-quality outputs from text-to-image models). As another example, when a particular AI model in a given workflow is exhibiting less than ideal rendering times, the system may select a given alternative AI model that is more resource-efficient when handling bulk or less complex tasks to be used for upstream content generation processes, thus ensuring the given workflow can be completed in a timely manner despite the delayed rendering from the particular AI model during a downstream content generation process.

In some implementations, the system may select multiple alternative AI models to replace or supplement a particular AI model that does not meet system performance benchmarks. For example, the system may replace a text-to-video model exhibiting less than ideal processing times with a new sequence of AI models including a text-to-image model followed by an image-to-video model based on the new sequence of AI models being associated with faster processing times. In some implementations, the system may select a single alternative AI model to replace or supplement multiple AI models that do not meet system performance benchmarks. For example, the system may replace a sequence of AI models that transform text to images to video clips with a single text-to-video AI model.

As another example, the system may supplement a sequence of AI models including a text-to-image model followed by an image-to-video model that is exhibiting low consistency in visual content of resulting video clips by placing a computer vision model in the sequence before the image-to-video model, wherein the computer vision model is configured to generate video prompts that specify movement parameters based on processing certain content generation parameters and the images generated by the text-to-image model. In such an example, the image-to-video model may receive both the generated images and the video prompts as inputs, instead of merely the images, thus increasing the image-to-video model's consistency in generating certain movements (e.g., a consistent running style and speed of a character across video clips). In some implementations, the system may store indications of multiple versions of a given automated content generation workflow in the database of performance metrics. Thus, the system may revert to prior versions of a given workflow if needed (e.g., based on server load, model load, user feedback, etc.).

In some implementations, the system may select an alternative AI model from the plurality of AI models that can be used in automated content generation workflows based on ranking the plurality of AI models (or a subset of the plurality of AI models) using the performance metrics of the database. For example, the system may determine, based on the performance metrics of the database, particular resource usage requirements for the plurality of AI models (or a given subset) to be used at one or more points during the given workflow, rank the plurality of AI models (or the given subset) based on their resource usage requirements at the one or more points during the given workflow, and then select a given alternative AI model for use at a given point during the given workflow based on the ranking(s).

In order to configure a selected alternative machine learning model for use in a given automated content generation workflow, the system may determine a particular configuration file associated with using the selected alternative machine learning model in the given workflow based on accessing a database of ML configuration files associated with the plurality of AI models. In some implementations, the system may determine a particular type of workflow, from a plurality of different types of workflows, that corresponds to the given workflow. In such implementations, the system may determine a particular configuration file to use for the selected alternative AI model based on determining that the particular configuration file is associated with both the particular type of workflow associated with the given workflow and the alternative AI model. For example, the system may identify a particular configuration file associated with configuring a particular image-to-video model in workflows that include text to image to video transformation sequences. As another example, the system may identify a particular configuration file associated with configuring LLMs to quickly provide short text snippets in workflows that use LLM transformation agents to transform inputs for multiple content generation steps.

The system uses the determined configuration file(s) to configure the alternative AI model(s) to be used in a given workflow. For example, the system may train, bias, or otherwise prime the alternative AI model(s) using the determined configuration file(s). Configuring a given alternative AI model tailors the alternative machine learning model to particular input and output formats associated with the particular workflow. For example, the system may use a given configuration file to configure a text-to-image model to generate image data that includes metadata tags indicating movement parameters, thus tailoring the output of the text-to-image model to the input format of an image-to-video model that generates video clips based on animating the images during a downstream content generation process of a given workflow. As another example, the system may use a different configuration file to configure an image-to-video model to derive movement parameters for animating an input sequence of images based on detecting changes between subsequent images in the sequence (e.g., images showing a character at point A then moved to point B relative to a background object).

The system may compare performance of the configured alternative AI model(s) in generating updated output(s) to the desired system quality benchmarks for a given workflow in order to validate that the version of the given workflow that uses the alternative AI model(s) should be provided for use to a user of an associated content generation system. For example, the system may monitor performance of a configured alternative text-to-image model in generating updated image data and compare that performance to a system performance benchmark associated with a maximum rendering time and/or a minimum level of rendering time improvement over previous performance of an image generation step in a given workflow. If performance of a given configured alternative AI model cannot be validated for a given workflow (e.g., if output quality does not satisfy content quality benchmarks), then the system may select one or more different configuration files for the given alternative AI model, configure one or more instances of the given alternative AI model using the one or more different configuration files, and then compare the outputs and/or performance metrics of the instance(s) of the given differently configured alternative AI model to the system quality benchmarks and/or to the outputs and/or performance metrics associated with different AI models used in previous version of the given workflow (e.g., to select which model or output shows the most improvement over the model or output that was determined to be deficient).

In response to the system validating the performance of a given configured alternative AI model, the system may modify similar automated content generation workflows in a similar manner. For example, the system may modify automated content generation workflows that: include the particular AI model associated with a deficiency or discrepancy in its outputs, include one or more other AI models that perform a similar function and/or are trained or biased similarly to the particular AI model (e.g., another AI model or sequence of AI models with similar input/output content types and formats), were generated based on a different iteration of the same predefined template, are associated with generating a similar type of multimedia content (e.g., a certain animation style or a certain animated show), are associated with a corresponding deficiency or discrepancy in its outputs (e.g., other workflows showing low visual consistency between sequential video clips), and/or are associated with a corresponding discrepancy or deficiency in performance for one or more AI models (e.g., workflows including other models showing high computing resource usage). The system may then modify the identified similar workflows that use the particular AI model to include the configured alternative AI model whose performance was validated for the given workflow.

Thus, the system may quickly catch performance issues during one workflow and not only optimize that workflow, but optimize other future workflows or future content generation steps in other workflows being currently performed. In some implementations, the system may cause one or more content generation steps associated with the given workflow and/or one of the other workflows that were optimized to be re-performed based on the addition of a new configured alternative AI model. For example, a content generation step associated with the particular AI model that was replaced or supplemented with a new configured alternative AI model may be re-performed (e.g., to ensure the output of that step meets quality benchmarks). In some such examples, downstream content generation steps that previously used inputs generated by the particular AI model that was replaced or supplemented may also be re-performed using the updated outputs generated by the new configured alternative AI model (e.g., to correct downstream quality issues).

### Structured Data Management for Multi-Layered Content Creation

In some embodiments, advanced data structures can be implemented to enable management of structured data for multi-layered content creation processes. Advanced data structures can databases of content templates, metadata structures, configuration files, training/biasing files, and performance metrics. This system or method uses these advanced data structures to track, evaluate, and modify AI model performance during automated content generation workflows that each include multiple sequences of AI models used during multiple sequences of content generation steps, ensuring optimal resource allocation and alignment with desired system benchmarks.

An exemplary implementation is provided below for the structured data management for multi-layered content creation:

The system may determine performance metrics for a plurality of AI models used during a plurality of automated content generation workflows. Each of the automated content generation workflows may include multiple sequences of corresponding AI models. For example, a given automated content generation workflow may include a first sequence of LLM to text-to-image model to image-to-video model associated with generating video clips including characters and may include a second sequence of LLM to text-to-video model associated with generating video intro and outro clips. As another example, a given automated content generation workflow may include a first sequence of three LLMs that generate, refine, and re-format content generation parameters for use in three separate downstream sequences of other AI models (e.g., a visual asset generation sequence, an audible asset generation sequence, and an asset synchronization sequence).

The system may determine performance metrics such as rendering time, cost efficiency, computational efficiency, and output quality for the plurality of AI models, the plurality of automated content generation workflows, and the multiple sequences of AI models associated with each of the plurality of automated content generation workflows. The system may determine the performance metrics based on ML configuration files defining capabilities of the AI models and further based on monitoring the performance of the AI models and the sequences of AI models during performance of automated content generation workflows. For example, the system may determine performance of a given text-to-image model for a given sequence that includes LLM to text-to-image model to image-to-video model for a given automated content generation workflow (e.g., a default workflow for a given content generation template) or given type of automated content generation workflow (e.g., all workflows for generating animated cartoons in a particular style that include that sequence of AI models or that sequence of input/output content types and formats).

The system may determine that a given AI model in a given sequence of AI models or a given sequence of AI models in a given workflow or type of workflow has underperformed or is likely to underperform based on the performance metrics. For example, the system may determine that a first sequence of AI models used to transform text content into video content for workflows associated with generating animated cartoon videos is less resource efficient than a different sequence of AI models (which includes at least one different AI model or includes the same AI models used in a different order) associated with the same type of workflow. The system may determine that the different sequence of AI models is more efficient than the first sequence of AI models based on determining that the different sequence of AI models provides outputs of a similar quality level to the first sequence of AI models in a shorter amount of time or using less computationally-demanding AI model(s). As another example, the system may determine that a given sequence of AI models is likely to result in unacceptably long rendering times based on determining rendering times of the individual models from the given sequence when they were used in different sequences (e.g., in a different order, with different models) in similar automated content generation workflows.

The system may modify corresponding automated content generation workflows when it determines that the given sequence of AI models and/or one of the AI models of the given sequence have underperformed or are likely to underperform. The system may modify the corresponding workflows by replacing one or more underperforming AI models in a given sequence of AI models with another AI model that performs a similar function (e.g., replacing a first text-to-image model with a second text-to-image model) or by replacing a sequence of AI models with a different sequence of AI models (e.g., replacing an “image prompt to reference image to video” sequence with a “video prompt to video” sequence). The system may determine the replacement AI model(s) and/or the replacement sequence(s) of AI models to optimize performance metrics of the corresponding workflows based on their project requirements. For example, the system may select particular sequences of AI models that prioritize speed for workflows (or types of workflows) that re-use those particular sequences of AI models at multiple stages. As another example, the system may select particular AI models that prioritize a high level of output detail to replace one or more underperforming AI models whose outputs are used to generate inputs for a relatively high number of other AI models in a given workflow (or type of workflow). In some implementations, determining the replacement AI model(s) and/or the replacement sequence(s) of AI models to optimize performance metrics of the corresponding workflows may include determining model performance requirements for a particular type of workflow based on corresponding performance metrics and ML configuration files, ranking a set of AI models based on their ability to satisfy the model performance requirements, and then selecting one or more given replacement AI models based on the ranking(s).

In implementations in which AI models or sequences of AI models are replaced for workflows that are currently being performed, the system may cause one or more previously performed steps of the modified workflow that were performed before the workflow was modified to be re-performed using the replacement AI model or sequence. For example, if an AI model that acts as an input adaptation layer and is included in multiple sequences of a workflow is replaced with a new AI model, the system may cause a first content generation process associated with a first sequence of the multiple sequences to be re-performed based on determining that re-performance of the first content generation process using the new AI model will result in a threshold level of improvement in output quality for the first content generation process, but the system may not cause a second content generation process associated with a second sequence of the multiple sequences to be re-performed based on determining that the level of improvement in output quality of the second content generation process is not enough to justify the resource usage required by re-performance of the second content generation process using the new AI model.

In some implementations, updated content generated using replacement AI models and/or replacement sequences of AI models may also be propagated through downstream content generation processes that have previously been performed during the corresponding workflows. For example, if a replacement LLM generates a new image prompt, a downstream image generation process associated with an un-modified sequence of different AI models may be re-performed using the new image prompt as input. As another example, if final video content has already been generated based on previously generated raw content assets, and a sequence of AI models is modified to include a new AI model that generates new raw content assets, the system may re-generate the final video content based on the new raw content assets and at least a portion of the previously generated raw content assets. After generating the final video content, the system may then cause the user devices associated with the users who requested corresponding content generation workflows to display the respective instances of final video content generated during the corresponding content generation workflows.

In some implementations, the system may validate performance of alternative AI models and/or alternative sequences of AI models for corresponding current workflows before making changes to particular workflows that are currently being performed. The system may validate that the modified versions of the particular current workflows that include the alternative AI models or sequences will still be able to meet corresponding project requirements after the modification. The system may validate performance of the alternative AI models or sequences for the current workflows based on comparing the updated content generated by the alternative AI models or sequences to other content generated by other AI models and/or sequences during the current workflows (e.g., comparing updated images to previously generated images, or comparing updated images to image generation parameters generated during a different process of the workflow). In such implementations, the system may only modify ongoing workflows if performance of the alternative AI models and/or sequence(s) of AI models can be validated for the particular project in which the corresponding workflow is being used.

In some implementations, the system may also validate performance of replacement AI models and/or replacement sequences of AI models in corresponding future workflows before making changes to the corresponding future workflows. For example, an instance of a first, unmodified workflow and an instance of the first workflow after it has been modified may each be performed (e.g., using default data, previous project data, etc.) and the outputs of each instance of the workflow may be compared to each other and/or system benchmarks. In such an example, the system may select either the unmodified or the modified version of the first workflow to be performed in the future based on how well the performance of each matches the project requirements of future user requests. For example, in response to receiving a future user request for “high-detail video for a flagship project”, the system may select the unmodified version of the first workflow because of its high-detail outputs in lieu of the modified version of the first workflow, which may be less computationally expensive but produce less-detailed outputs.

In some implementations, in response to being unable to validate performance of alternative AI models and/or alternative sequences of AI models based on their performance metrics, the system may compare instances of updated content generated by the alternative AI models and/or alternative sequences of AI models to instances of previously generated content that were generated by corresponding AI models and/or sequences of AI models during the un-modified instances of the given workflows, and the system may determine whether to modify the given workflows. For example, if multiple given workflows including a particular AI model are associated with high rendering times and low audio fidelity, and modified versions of the given workflows (e.g., including alternative AI models) are associated with lower rendering times and higher audio fidelity but lower visual consistency, the system may not be able to validate that performance of the modified versions of the workflows have improved at least a threshold level amount (e.g., due to a mix or pros and cons to using the modified workflow). In such an example, the system may compare the video clips and audio clips generated by the unmodified and modified versions of the workflow and determine that only workflows associated with generating animated cartoons should be modified to include the alternative AI models (e.g., due to lower visual consistency being less noticeable in cartoons versus photo-realistic content).

In some implementations, in response to being unable to validate performance of alternative AI models and/or alternative sequences of AI models for a given workflow (or type of workflow) based on their new performance metrics generated during the validation process, the system may determine updated model performance requirements based on the new performance metrics, rank a different set of AI models based on their ability to satisfy the updated model performance requirements, select a different alternative AI model and/or sequence of AI models based on the ranking, and then modify the current sequence of AI models for the given workflow (or type of workflow) that was associated with underperformance of a deficiency to include the different alternative AI model and/or sequence of AI models.

In some implementations, validating performance of the replacement AI models may include determining a relative position in a content timeline associated with the audio and video clips generated by the unmodified and modified versions of a given workflow. For example, the system may compare a first audio clip generated during an unmodified version of a workflow with a second audio clip generated during a modified version of the workflow based on determining that the first audio clip and second audio clip both correspond to the same relative position in the content timeline (e.g., both capture the same character speaking the same line). In such examples where relative positions within a content timeline are determined for video clips and audio clips generated during workflows, the system may further use the relative positions and the content timeline in generating the final video content to provide to the requesting user. The system may synchronize the video clips and audio clips to be used in generating the final video content based on their relative positions within the content timeline.

### User-Prompted Personalized Content Generation

In some embodiments, automated content generation workflows can be modified based on user feedback to enable dynamic personalization of content generation processes during performance of the automated content generation workflows based on user feedback prompts. This system or method presents users with content previews of text content, visual content, and/or audible content generated during various steps of a workflow along with prompts for user feedback. This system or method may determine desired modifications to the generated text content, visual content, or audible content generated based on the user feedback. This system or method may then modify at least a portion of the corresponding workflow and cause the modified workflow to generate new text content, visual content, or audible content that includes the desired modifications.

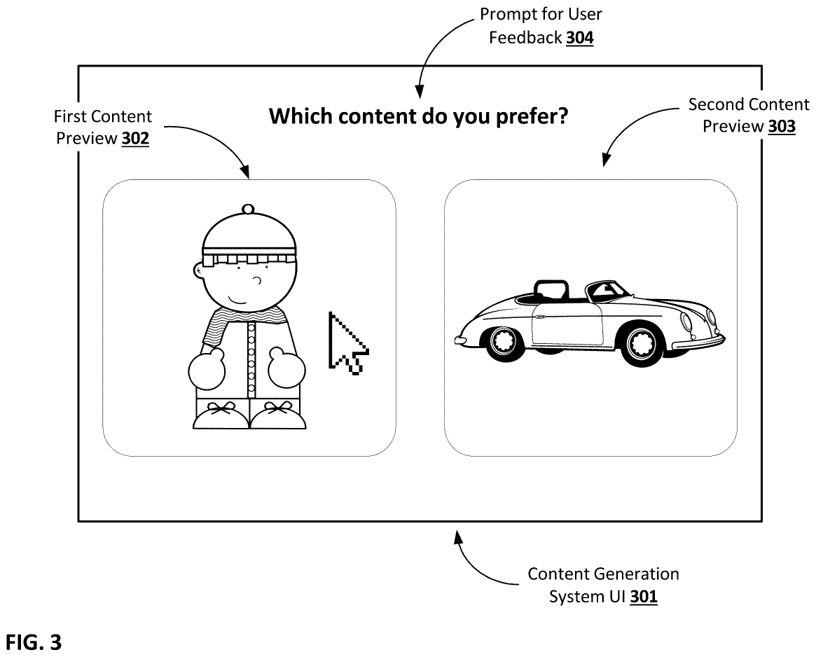

FIG. 3 depicts an example user interface of the automated content generation system requesting feedback from the user. The content generation system UI 301 displayed on the user device of the user includes a first content preview 302 and a second content preview 303 along with a prompt for user feedback 304 that prompts the user to select the content preview 302-303 that the user prefers.

An exemplary implementation is provided below for modifying automated content generation workflows based on user feedback to enable dynamic personalization of content generation processes of the workflows:

The system receives user inputs and determines a plurality of user preferences associated with a user profile of the user. Users provide user inputs to a UI associated with the system on their user devices. User preferences may be provided to the system as user inputs, or the system may determine user preferences based on past user inputs, content generation history, and/or content viewing history. The system may store user preferences in association with a user account of the content generation system (e.g., a user profile or account on a content generation platform). User inputs and/or user preferences may indicate story genre or theme (e.g., adventure, mystery, comedy), character traits (e.g., brave, curious, mischievous), stylistic preferences (e.g., whimsical, realistic, humorous), and desired formats (e.g., short episodes, feature-length content). In some implementations, user inputs may include natural language prompts. For example, the user may input “create a story about a curious cat exploring a magical forest with a humorous tone.” In some implementations, the user may input a reference image (e.g., an image of a person they want incorporated into the media content).

The system determines content generation parameters based on a user request for content generation received from a user and a plurality of user preferences associated with a user profile of the user. The system may process indications of user inputs and/or user preferences using one or more AI models (e.g., an LLM or image-to-text model) to generate structured metadata indicating content generation parameters to be used by a plurality of AI models during an automated content generation workflow.

The system generates, based on the content generation parameters, an automated content generation workflow for generating video content responsive to the user request for content generation. The automated content generation workflow includes a sequence of steps, each associated with at least one corresponding AI model from a plurality of AI models. In some implementations, the automated workflow further includes an input adaptation layer that transforms different types of content into various forms of structured metadata depending on an input format associated with one or more of the AI models associated with a given step of the workflow. In some implementations, the system may assign one or more transformation AI agents to generate the inputs to one or more steps or AI models of the workflow based on the outputs of upstream steps or AI models and the input requirements of the current steps or AI models (e.g., as indicated by ML configuration files). The system may determine which AI models, from the plurality of AI models, to include in a given workflow based on determining input and output formats of each of the plurality of AI models (e.g., using ML configuration files) and based on determining a sequence of data transformations to transform the content generation parameters into the requested video content using the determined input and output formats of the plurality of AI models.

In some implementations, the system may determine, based on comparing the content generation parameters to a plurality of templates in a template database, which template of the plurality of templates is most similar to the content generation parameters. In such implementations, the system may further generate the workflow based on the determined template. Moreover, the system may train one or more AI models to be included in a given workflow based on the determined template before performing one or more particular steps of the workflow associated with the one or more AI models. For example, the system may generate a plurality of instances of audio training data each associated with a different voice fingerprint based on content parameters associated with characters speaking and further based on the determined template (e.g., indicating default voice characteristics for characters). In such an example, the system may rank the generated instances of audio training data based on similarity of the different voice fingerprints to the determined template and the content generation parameters (e.g., with instances corresponding to voice fingerprints that more closely correspond to both the determined template and the content generation parameters being ranked higher). The system may then select a given instance of audio training data based on the ranking and use the given instance of audio training data to train a given AI model (e.g., the AI model that generates audio data for a given character) to generate audio that corresponds to the voice fingerprint associated with the given instance of audio training data.

The system performs the sequence of steps of the automated workflow to generate multimedia content responsive to the user request for content generation. The system applies the content generation parameters as input to a first step in the sequence of steps of the workflow. For each subsequent step, the system generates a given input in an input format corresponding to at least one AI model associated with the subsequent step based on processing one or more outputs of preceding steps using the input adaptation layer. For example, the content generation parameters may be applied as inputs to a first scriptwriting step associated with an AI scriptwriting agent that outputs a script in tabular format. An input adaptation layer may then process the tabular script to generate an image prompt to generate a reference image for a given character based on the input requirements of the text-to-image model that is to receive the image prompt in a subsequent step.

Once performance of one or more of the given steps in a sequence of steps of a workflow has been completed, the system may cause a user device of the user to display a prompt for user feedback along with a content preview of any text content, visual content, audio content, or video content generated during the given step. For example, after generating the script, the system may display at least a portion of the script for user review. As another example, after generating a video clip, the system may cause at least a portion of the video clip to play on the UI. The prompt for user feedback may include one or more fields or user selection options, such as a field for natural language feedback, thumbs up/down indicators, a rating out of 10, or multiple choice options for feedback. The user may provide the user feedback in the form of user inputs or selections responsive to the prompt.

The system may determine an intended modification associated with the particular instance of text content, visual content, or audio content generated during a given step of a workflow based on the user feedback received in association with that particular instance of content for the given step. For example, the user may provide natural language feedback of “make the car braver and the forest darker”, and the system may determine updated story and visual parameters reflecting the revised tone and character traits. The system may determine one or more preceding steps of the workflow that are associated with the downstream generation of the particular instance of text content, visual content, or audio content at the given step. For example, the system may determine that script parameters generated during a previous step were used to generate the audio content during the given current step. The system may modify the outputs of one or more preceding steps based on the intended modification to the particular instance of text content, visual content, or audio content generated at the given step. The modification may include processing an indication of an intended modification with one or more of the outputs generated during one or more previous steps using the input adaptation layer to generate at least one modified input for a downstream step (e.g., the given step or another downstream step that precedes the given step). In response to performing the modification, the system re-generates the particular instance of text content, visual content, or audio content associated with the given step using at least the modified input associated with the given step. In implementations in which multiple steps of the sequence of steps are modified for a workflow, the system may cause each step to re-generate corresponding outputs based on their modified inputs (e.g., cause the workflow to be performed again from the first modified step and propagating the new outputs downstream to be used as inputs along with any other modified inputs that were generated).

When the system completes the sequence of steps for the given workflow, including any modifications determined based on the user feedback, the system generates the final multimedia content (e.g., video content) based on the various outputs generated during the workflow, including any particular instances of text content, visual content, or audio content that were re-generated based on modifications to the workflow made responsive to user feedback. In some implementations, the system may cause a user device associated with the user who requested content generation to display the video content with an additional prompt for feedback. The system may receive an indication of the user's feedback provided in response to the prompt. In such implementations, the system may modify the workflow based on the user's feedback by modifying an input, including an additional input, training or configuring a given AI model, and/or modifying the user preferences of the user.

For example, the user may provide feedback that requests addition of an entity (e.g., a character or object) to the video content, the system may determine one or more particular steps in the sequence of steps of the workflow are associated with generation of the visual content or the audio content of a given scene in the video content, generate an additional input based on the entity (e.g., based on generating new content generation parameters for the entity), re-generate the visual content or the audio content of the given scene based on re-performing the one or more particular steps using the additional input, and then generate updated video content based at least in part on the re-generated visual content or the re-generated audio content. In some such examples, the system may further determine that one or more AI models associated with the one or more particular steps are not trained to generate visual data or audio data of the entity (e.g., toothbrush); obtain a model configuration file associated with the entity (e.g., an object definition file for modeling a toothbrush in a first animation style); generate one or more instances of training data for the one or more corresponding AI models based on the model configuration file, the content generation parameters associated with the corresponding AI models for the particular steps (e.g., indicating animation style parameters for a second animation style), and the user input received responsive to the additional prompt for feedback (e.g., indicating when or how the toothbrush should be used in the video); and train the corresponding AI models using the one or more instances of training data such that the trained AI models can generate visual and/or audio data of the requested entity.

In implementations in which the user request for content generation includes a reference image (e.g., a photo of themselves with a request to be the main character), the system may determine at least one AI model included in the workflow that corresponds to a particular step of the workflow where reference image data is generated (e.g., a step associated with a text-to-image model that generates reference images of the main character). The system may then generate training data for the at least one AI model using the reference image. For example, the system may use the reference image to train a LoRA model to generate training data for the at least one AI model. The system may then train the at least one AI model using the training data to cause the at least one AI model to be configured to generate visual data that looks like the reference image (e.g., an AI model that generates reference images of a default mouse main character will now generate images of a mouse that looks more like the user).

In some implementations, the system may update the user preferences associated with the user profile of a user based on the feedback received from the user for a given workflow. The system may also update other instances of user preferences associated with other user profiles of other users based on feedback received from those other users during other workflows. The system may then determine patterns of user preferences based on the updated user preferences of the user and the other users. In some implementations, the system may generate modified inputs to one or more AI models of the given workflow or the other workflows based on at least one of the determined patterns of user preferences. For example, if multiple users request that a given animation style included in their videos be tweaked to include more three-dimensional (“3D”) elements (e.g., depth, shadows, etc.), then the system may modify inputs to AI models that generate visual content to indicate parameters for generating 3D visual content. The system modifies the inputs for workflows of the multiple users, for all workflows of all users that correspond to the same type of workflow (e.g., same animation style), or for all workflows of users associated with similar user preferences as the multiple users that made the requests.

### Select Examples

The following paragraphs provide various examples of the embodiments disclosed herein.
Example 1 provides a computer-implemented method for an automated workflow that transforms user prompts into multimedia content using multiple artificial intelligence (“AI”) driven stages, comprising: receiving user input indicating a user prompt for content generation provided by a user via a user device; performing a sequence of content generation steps associated with an automated workflow to generate video content responsive to the user prompt for content generation, where one or more of the content generation steps of the sequence are associated with at least one machine learning model selected from a plurality of machine learning models; monitoring performance of the automated workflow based on monitoring outputs received from corresponding machine learning models from the plurality of machine learning models; generating, based on the monitoring, a biasing protocol for at least one machine learning model from the plurality of machine learning models associated with at least one content generation step in the sequence of content generation steps; biasing the at least one machine learning model using the biasing protocol, wherein biasing the at least one machine learning model causes the at least one machine learning model to output different content during performance of the at least one content generation step after the biasing; repeating the automated workflow from the at least one content generation step using the biased at least one machine learning model, wherein repeating the automated workflow from the at least one content generation step includes repeating the at least one content generation step and any downstream content generation steps in the sequence; and causing a display associated with the user device of the user to display a video generated based on the different content generated by the at least one machine learning model during the at least one content generation step and based on other content generated by the plurality of machine learning models during other content generation steps in the sequence of content generation steps.
Example 2 provides the method of example 1, wherein performing the sequence of content generation steps of the automated workflow includes: generating reference data for downstream visual asset and audible asset generation based on the user prompt for content generation; generating visual content generation parameters and audible content generation parameters based on the reference data associated with downstream visual asset and audible asset generation using one or more second machine learning models from the plurality of machine learning models; generating a plurality of video clips based on processing the visual content generation parameters using one or more third machine learning models from the plurality of machine learning models, wherein the one or more third machine learning models are image-to-video models; generating a plurality of audio clips based on processing the audible content generation parameters using one or more fourth machine learning models from the plurality of machine learning models, wherein the one or more third machine learning models are text-to-sound models; and generating the video based on the plurality of video clips and the plurality of audio clips using one or more fifth machine learning models from the plurality of machine learning models.
Example 3 provides method of example 2, wherein generating the reference data includes generating a reference table using one or more first machine learning models from the plurality of machine learning models, and the reference table includes a tabular representation of the reference data.
Example 4 provides the method of example 2, wherein the audible content generation parameters are in text format and the visual content generation parameters are in image format.
Example 5 provides the method of example 2, further comprising: generating text content indicating a narrative framework and script based on the user prompt for content generation using one or more additional machine learning models from the plurality of machine learning models, wherein generating the reference data is further performed based on the narrative framework and the script.
Example 6 provides the method of example 5, wherein generating the narrative framework and the script includes: determining one or more content templates from a plurality of content templates based on the user prompt for content generation; and determining characters, settings, and contexts associated with the narrative framework and the script based on the one or more content templates.
Example 7 provides a computer-implemented method for maintaining narrative and visual consistency across multiple stages of a multimedia content generation process, comprising: receiving user input indicating a user prompt for content generation; determining an order of use for a set of machine learning models based on the user prompt for content generation, wherein order of use for the set of machine learning models is determined such that each machine learning model processes inputs in the order of use in a format corresponding to an output format of a preceding machine learning model; generating a dynamic reference table based on the user prompt for content generation and the order of use, the dynamic reference table including a plurality of entries each associated with at least one corresponding machine learning model from the set of machine learning models and each associated with reference data for visual or audible asset generation; performing a plurality of content generation processes in accordance with the order of use for the set of machine learning models, wherein performing the plurality of content generation processes includes updating the dynamic reference table to include outputs generated during the plurality of content generation processes including video clips and audio clips generated based on the reference data included in the dynamic reference table; generating updated reference data based on determining that particular reference data included in a particular entry from the plurality of entries in the dynamic reference table is associated with at least one of the outputs failing to satisfy one or more criteria; updating at least one other entry from the plurality of entries of the dynamic reference table based on the updated reference data; re-generating downstream content starting from a point during the plurality of content generation processes corresponding to the at least one updated entry of the dynamic reference table; and generating video content responsive to the user prompt for content generation based on the video clips and the audio clips, wherein the video clips and the audio clips used to generate the video content exclude the at least one of the outputs that failed to satisfy the one or more criteria, and wherein at least one of the video clips or the audio clips includes the downstream content that was re-generated.
Example 8 provides the method of example 7, wherein determining that the particular reference data included in a particular entry from the plurality of entries in the dynamic reference table is associated with at least one of the outputs failing to satisfy one or more criteria includes comparing the outputs generated during the plurality of content generation processes to one or more of: benchmark criteria determined based on viewing metrics associated with other video content, another one or more of the outputs, and any of the outputs or the reference data included in one or more other entries from the plurality of entries in the dynamic reference table.
Example 9 provides the method of example 7, wherein generating the updated reference data includes generating multiple instances of updated reference data; and further comprising: generating additional video content responsive to the user prompt for content generation based on the outputs that were generated prior to updating the at least one other entry.
Example 10 provides the method of example 9, further comprising: causing a display device associated with a user device that provided the user input to display corresponding previews of the video content and the additional video content with a prompt for a user of the user device to select either the video content or the additional video content.
Example 11 provides the method of example 10, wherein the at least one other entry is associated with a particular machine learning model from the set of machine learning models; and further comprising: generating training data based on a user selection received responsive to the prompt.
Example 12 provides the method of example 11, further comprising: training at least one machine learning model based on the training data, wherein the at least one machine learning model includes one or more of: the particular machine learning model, and an additional machine learning model that determined that the at least one of the outputs did not satisfy the one or more criteria.
Example 13 provides a computer-implemented method for optimizing inputs to downstream artificial intelligence (“AI”) models during an automated content generation workflow, comprising: determining, based on a script generated responsive to a user prompt for content generation, a set of machine learning models and corresponding content generation parameters to be used during a sequence of content generation processes; generating a plurality of system prompts for biasing the set of machine learning models, wherein the plurality of system prompts are generated such that, after biasing the set of machine learning models, each biased machine learning model associated with a current content generation process in the sequence of content generation processes will process inputs in a format corresponding to outputs of a different machine learning model used during a previous content generation process in the sequence of content generation processes; biasing the set of machine learning models using the plurality of system prompts; performing the sequence of content generation processes including generating: text content using one or more first biased large language models from the set of biased machine learning models and one or more of the corresponding content generation parameters, a reference table including visual reference data and audible reference data based on the text content using one or more second biased large language models from the set of biased machine learning models, video clips based on the visual reference data using at least one biased text-to-image model and at least one biased image-to-video model from the set of biased machine learning models, audio clips based on the audible reference data, the visual reference data, and the text content using one or more biased text-to-sound models from the set of biased machine learning models, and video content based on the video clips, the audio clips, and the reference table using one or more other biased machine learning models from the set of biased machine learning models; and in response to detecting, during performance of the sequence of content generation processes, a discrepancy between one or more of the outputs generated during a current content generation process and an input format associated with a given biased machine learning model from the set of biased machine learning models that is associated with a subsequent content generation process in the sequence of content generation processes, implementing acts comprising: generating a modified input for the given biased machine learning model associated with the subsequent content generation process in the sequence of content generation processes; and causing at least a portion of the sequence of content generation processes associated with the given biased machine learning model to be performed again based on the modified input, wherein causing the at least a portion of the sequence of content generation processes associated with the given biased machine learning model to be performed again further causes other downstream content generation processes from the sequence of content generation processes to be performed again.
Example 14 provides the method of example 13, further comprising: performing a validation process associated with the current content generation process to validate performance of the given biased machine learning model based on comparing a given output generated by the given biased machine learning model based on the modified input to the visual reference data or the audible reference data in the reference table.
Example 15 provides the method of example 14, wherein causing the at least a portion of the sequence of content generation processes associated with the given biased machine learning model to be performed again based on the modified input is performed responsive to validating the performance of the given biased machine learning model.
Example 16 provides the method of example 14, further comprising: in response to being unable to validate the performance of the given biased machine learning model, implementing acts comprising: generating an updated modified input; performing another validation process to validate performance of the given biased machine learning model with the updated modified input; and causing the at least a portion of the sequence of content generation processes associated with the given biased machine learning model to be performed again based on the updated modified input.
Example 17 provides the method of example 13, wherein causing the at least a portion of the sequence of content generation processes associated with the given biased machine learning model to be performed again based on the modified input includes generating second video clips that are different from the video clips previously generated; and further comprising: generating, based on comparing the video clips to the second video clips and further based on comparing the one or more of the outputs to the modified input, training data; and training the given biased machine learning model based on the training data.
Example 18 provides the method of example 13, wherein detecting the discrepancy is performed by an additional biased machine learning model from the set of biased machine learning models.
Example 19 provides the method of example 18, wherein generating the modified input is performed by the additional biased machine learning model.
Example 20 provides the method of example 18, wherein generating the modified input is performed by a different biased machine learning model from the set of biased machine learning models.
Example 21 provides the method of example 13, wherein generating the modified input for the biased given machine learning model associated with the subsequent content generation process includes generating the modified input using an additional biased machine learning model from the set of biased machine learning models, wherein the additional biased machine learning model is selected based on the discrepancy associated with the one or more outputs.
Example 22 provides the method of example 13, wherein the one or more biased text-to-sound models include multiple biased machine learning models from the set of biased machine learning models; and wherein generating the audio clips based on the audible reference data, the visual reference data, and the text content using the one or more biased text-to-sound models includes: generating a first portion of the audio clips based on applying inputs generated based on the audible reference data and the visual reference data to a first machine learning model of the multiple biased machine learning models, wherein the first machine learning model is a text-to-speech machine learning model; and generating a second portion of the audio clips based on applying inputs generated based on the audible reference data, the visual reference data, and at least a portion of the text content to a second machine learning model of the multiple biased machine learning models, wherein the second machine learning model is a text-to-sound machine learning model.
Example 23 provides the method of example 22, wherein generating the inputs based on the audible reference data and the visual reference data to apply to the first machine learning model and generating the inputs based on the audible reference data, the visual reference data, and at least a portion of the text content to apply to the second machine learning model are performed by respective different machine learning models from the multiple biased machine learning models.
Example 24 provides the method of example 13, wherein generating the video clips based on the visual reference data using the at least one biased text-to-image model and the at least one biased image-to-video model includes: generating training data for the at least one biased text-to-image model based on a first portion of the visual reference data; training the at least one biased text-to-image model using the training data; generating one or more reference images based on applying a second portion of the visual reference data as input to the at least one trained biased text-to-image model; generating video generation prompts based on a third portion of the visual reference data using an additional machine learning model of the multiple biased machine learning models; and generating the video clips based on applying the one or more reference images and the video generation prompts as inputs to the at least one biased image-to-video model.
Example 25 provides the method of example 13, wherein generating the video clips and the audio clips includes generating metadata associated with the video clips and the audio clips; and wherein generating the video content is performed further based on the metadata associated with the video clips and the audio clips.
Example 26 provides the method of example 23, wherein generating the modified input for the given biased machine learning model includes: generating a modified biasing protocol generated for a different biased machine learning model from the set of biased machine learning models that is associated with a preceding content generation process in the sequence of content generation processes based on the detected discrepancy; using the modified biasing protocol to re-bias the different biased machine learning model; and in response to re-biasing the different biased machine learning model associated with the preceding content generation process, causing the preceding content generation process to be performed again.
Example 27 provides the method of example 13, further comprising: in response to detecting, during performance of the sequence of content generation processes, an additional discrepancy between two or more of the outputs generated during two or more particular content generation processes of the sequence of content generation processes, implementing acts comprising: generating an external input for at least one corresponding biased machine learning model from the set of biased machine learning models that are associated with at least one of the two or more particular content generation processes; and causing at least a given portion of the sequence of content generation processes associated with the at least one corresponding biased machine learning model to be performed again based on the external input, wherein causing the at least the given portion of the sequence of content generation processes associated with the one or more corresponding biased machine learning models to be performed again further causes other downstream content generation processes from the sequence of content generation processes to be performed again.
Example 28 provides the method of example 27, wherein the additional discrepancy is determined based on comparing at least one of the video clips to at least a portion of the visual reference data included in the reference table.
Example 29 provides the method of example 27, wherein the additional discrepancy is determined based on comparing at least one of the audio clips to at least a portion of the audible reference data included in the reference table.
Example 30 provides the method of example 13, wherein the set of biased machine learning models includes at least one prompt-generation agent that adapt inputs for one or more given content generation processes from the sequence of content generation processes; and wherein inputs for each of the one or more given content generation processes are generated by the corresponding at least one prompt-generation agent based on the outputs generated during one or more upstream content generation processes in the sequence of content generation processes and further based on one or more corresponding input formats associated with one or more corresponding biased machine learning models used during the given content generation process.
Example 31 provides a computer-implemented method for refining and optimizing future content generation workflows based on user feedback, comprising: generating videos based on video segments generated using content generation reference tables, wherein each of the content generation reference tables includes entries associating content generation parameters and content generation models with a corresponding sequence of content generation steps; receiving incidence information for viewer engagement actions taken by a plurality of viewers while the plurality of viewers were viewing the videos, wherein the incidence information is determined based at least in part on user input data from user devices associated with the plurality of viewers; determining, based on processing the incidence information in association with corresponding indications of associated videos from the videos and associated video segments from the videos segments using at least one machine learning model, patterns of viewer behavior associated with particular videos from the videos and particular video segments from the video segments; modifying, for each given video segment from the particular video segments in each given particular video from the particular videos, corresponding entries from the entries in corresponding content generation reference tables from the content generation reference tables to include updated content generation parameters, wherein the updated content generation parameters are associated with modifying the patterns of viewer behavior associated with the respective video segment; and generating a plurality of new videos based on performing particular content generation steps from the corresponding sequences of content generation steps associated with the updated content generation parameters in the corresponding content generation reference tables, wherein the particular content generation steps include content generation steps associated with the corresponding entries including the updated content generation parameters and any downstream content generation steps in the corresponding sequences of content generation steps.
Example 32 provides the method of example 31, further comprising: receiving updated incidence information for a second set of viewer engagement actions taken by the plurality of viewers while the plurality of viewers were viewing the plurality of new videos; and determining corresponding improvement scores associated with the plurality of new videos.
Example 33 provides the method of example 32, further comprising: generating, based on the updated content generation parameters and the corresponding improvement scores, training data associated with at least one machine learning model that was used to process the updated content generation parameters; and training the at least one machine learning model based on the training data.
Example 34 provides the method of example 32, further comprising: determining a particular template from a plurality of corresponding templates that is associated with generating a particular one of the plurality of new videos associated with a particular one of the corresponding improvement scores; and generating a modified version of the particular template based on the updated content generation parameters and the particular one of the corresponding improvement scores.
Example 35 provides the method of example 31, further comprising: determining, for each respective video segment from the particular video segments and based on the corresponding content generation reference tables, corresponding points during the corresponding sequences of content generation steps associated with the respective video segments; and determining the downstream content generation steps based on the corresponding points during the corresponding sequences of generation steps associated with the respective video segments.
Example 36 provides the method of example 31, further comprising: storing, in a centralized feedback database, the incidence information with corresponding indications of the associated videos from the videos and the associated video segments from the video segments.
Example 37 provides the method of example 31, wherein modifying, for each given video segment from the particular video segments in each given particular video from the particular videos, the corresponding entries in the corresponding content generation reference tables to include the updated content generation parameters includes: generating, for each respective video segment from the particular video segments and based on the patterns of viewer behavior associated with the respective video segment, the updated content generation parameters associated with modifying the patterns of viewer behavior associated with the respective video segment; and storing the updated content generation parameters in the corresponding content generation reference tables in corresponding entries from the entries.
Example 38 provides the method of example 31, further comprising: identifying, for at least one video from the plurality of new videos, a plurality of different iterations of the at least one video that were generated based on different content generation parameters in the corresponding content generation reference table; and determining, based on incidence information for different viewer engagement actions taken by the plurality of viewers while the plurality of viewers were viewing the plurality of different iterations of the at least one video, a particular iteration of the different content generation parameters associated with satisfying one or more criteria.
Example 39 provides the method of example 38, further comprising: generating, based on determining the particular iteration of the different content generation parameters associated with satisfying the one or more criteria, modified content generation parameters for a different content generation reference table corresponding to a different video in the plurality of new videos; and generating a new version of the different video using the modified content generation parameters.
Example 40 provides the method of example 31, wherein the viewer engagement actions indicated by the incidence information include indications of one or more of: user selections, user view times, and viewer drop-off times.
Example 41 provides a computer-implemented method for a modular content generation workflow that enables swapping of artificial intelligence (“AI”) models without disrupting the workflow, comprising: generating a database of performance metrics associated with a plurality of machine learning models that were used by a plurality of workflows to generate a plurality of videos, wherein each of the plurality of workflows uses multiple machine learning models from the plurality of machine learning models, and wherein the performance metrics are determined based on resource usage and outputs of the plurality of machine learning models during the plurality of workflows; determining, based on the database of performance metrics, that there is a discrepancy or deficiency in performance for a particular machine learning model from the plurality of machine learning models during a particular workflow from the plurality of workflows; determining, based on the database of performance metrics, an alternative machine learning model from the plurality of machine learning models to be used for the particular workflow; determining, based on accessing a database of configuration files for the plurality of machine learning models, a particular configuration file associated with the alternative machine learning model; configuring the alternative machine learning model using the particular configuration file, wherein configuring the alternative machine learning model tailors the alternative machine learning model to particular input and output formats associated with the particular workflow; comparing updated output generated using the configured alternative machine learning model to one or more content quality benchmarks associated with the particular workflow; and in response to validating an output quality of the configured alternative machine learning model based on the one or more content quality benchmarks, implementing the acts comprising: modifying given workflows from the plurality of workflows that are associated with the determined particular workflow and include the particular machine learning model, wherein the modifying includes substituting the particular machine learning model with the configured alternative machine learning model in the given workflows; and in response to modifying the given workflows, causing the given workflows to re-generate any previously generated content that was generated during the given workflows by the particular machine learning model or was generated based on any inputs generated based on data included in intermediary outputs of the particular machine learning model.
Example 42 provides the method of example 41, wherein the plurality of workflows each define a sequence of content generation steps, and wherein causing the given workflows to re-generate the previously generated content is further performed for any downstream content generation steps in the sequences of content generation steps associated with the given workflows.
Example 43 provides the method of example 41, further comprising: determining a particular type of workflow from the plurality of workflows that corresponds to the discrepancy or deficiency in performance for the particular machine learning model, wherein the given workflows correspond to the particular type of workflow.
Example 44 provides the method of example 43, wherein determining, based on accessing the database of configuration files for the plurality of machine learning models, the particular configuration file associated with the alternative machine learning model is further performed based on determining that the particular configuration file is associated with the particular type of workflow.
Example 45 provides the method of example 41, wherein causing the given workflows to re-generate the previously generated content includes causing the given workflows to generate a plurality of updated videos; and further comprising: determining updated performance metrics for the plurality of updated videos; and modifying the given workflows by substituting the particular machine learning model for the configured alternative machine learning model in the given workflows based on the updated performance metrics.
Example 46 provides the method of example 41, wherein determining, based on the database of performance metrics, the alternative machine learning model to be used for the particular workflow includes: determining resource usage requirements of the plurality of machine learning models for the particular workflow; ranking the plurality of machine learning models based on the resource usage requirements for the particular workflow; and selecting the alternative machine learning model from the plurality of machine learning models based at least in part on the ranking.
Example 47 provides the method of example 41, wherein determining, based on the database of performance metrics, the alternative machine learning model to be used for the particular workflow includes: determining resource usage requirements of the plurality of machine learning models for the particular workflow; ranking the plurality of machine learning models based on the resource usage requirements for the particular workflow; and selecting the alternative machine learning model from the plurality of machine learning models based at least in part on the ranking.
Example 48 provides the method of example 41, further comprising: in response to failing to validate the output quality of the configured alternative machine learning model based on the one or more content quality benchmarks, implementing acts comprising: determining, based on accessing the database of configuration files for the plurality of machine learning models, a different configuration file associated with the alternative machine learning model; re-configuring the alternative machine learning model using the different configuration file; and comparing second updated output generated using the re-configured alternative machine learning model to one or more content quality benchmarks associated with the particular workflow.
Example 49 provides the method of example 48, further comprising: re-configuring the alternative machine learning model using a plurality of different configuration files from the database of configuration files to generate a plurality of instances of the re-configured alternative machine learning model; comparing additional updated outputs generated using the plurality of instances of the re-configured alternative machine learning model; and selecting a given one of the plurality of different configuration files based on the comparisons of the additional updated outputs.
Example 50 provides a computer-implemented method for managing automated workflows for multi-layered content generation, comprising: determining performance metrics for a plurality of machine learning models during performance of a plurality of content generation workflows, wherein each of the plurality of content generation workflows defines multiple sequences of machine learning models from the plurality of machine learning models; modifying, based on the performance metrics, a given sequence of machine learning models from the multiple sequences of machine learning models for one or more given content generation workflow from the plurality of content generation workflows, wherein the modifying includes replacing one or more of the machine learning models from the one or more given sequences that are underperforming with alternative machine learning models from the plurality of machine learning models; re-performing one or more of previously performed steps of the one or more given content generation workflows that were performed using data generated by the underperforming machine learning models, wherein re-performing the previously performed steps of the one or more given content generation workflows includes generating one or more instances of updated content for each of the one or more given content generation workflows; validating performance of the alternative machine learning models based on comparing the one or more instances of updated content generated by the modified sequence of machine learning models to one or more instances of other content generated during a different sequence of machine learning models from the multiple sequences of machine learning models for the one or more given content generation workflows; and in response to validating the performance of the alternative machine learning models, implementing the actions comprising: generating, for each of the one or more given content generation workflows, video content based on outputs of the modified sequence of machine learning models, wherein the outputs include at least the one or more instances of updated content and the one or more instances of other content; and causing a plurality of user devices associated with a plurality of users who initiated performance of the one or more given content generation workflows to display the video content corresponding to the one or more given content generation workflows.
Example 51 provides the method of example 50, further comprising: in response to being unable to validate the performance of the alternative machine learning models, implementing acts comprising: comparing the one or more instances of updated content generated by the modified sequence of machine learning models to one or more previously generated instances of content that were generated by the given sequence of machine learning models prior to the modification; and determining, based on the performance metrics and the comparison between the one or more instances of updated content and the one or more previously generated instances of content, whether to modify the different sequence of machine learning models from the multiple sequences of machine learning models for the one or more given content generation workflows.
Example 52 provides the method of example 50, further comprising: propagating the one or more instances of updated content through at least one other sequence of machine learning models from the multiple sequences of machine learning models associated with the one or more given content generation workflows.
Example 53 provides the method of example 50, wherein validating the performance of the alternative machine learning models includes determining a relative position in a content timeline associated with each of the one or more instances of updated content and the one or more instances of other content.
Example 54 provides the method of example 53, wherein generating the video content is performed further based on synchronizing the one or more instances of updated content and the one or more instances of other content generated by the multiple sequences of machine learning models for the one or more given content generation workflows based on the determined content timeline.
Example 55 provides the method of example 50, further comprising: determining, based on accessing a database of configuration files associated with the plurality of machine learning models, a particular type of workflow from a plurality of types of workflows that is associated with one or more of the performance metrics, wherein the particular type of workflow defines a format for a sequence of inputs and outputs; and selecting the one or more given content generation workflows from the plurality of content generation workflows for modification based on determining that the one or more given content generation workflows correspond to the particular type of workflow.
Example 56 provides the method of example 55, further comprising: determining model performance requirements for the particular type of workflow based on the performance metrics and the configuration files; ranking a portion of the plurality of machine learning models based on the model performance requirements, wherein the portion includes the alternative machine learning models and at least one additional machine learning model; and selecting the alternative machine learning models from the plurality of machine learning models based on the ranking of the portion of the plurality of machine learning models.
Example 57 provides the method of example 56, further comprising: in response to being unable to validate the performance of the alternative machine learning models, implementing acts comprising: determining updated model performance requirements based on new performance metrics generated for the alternative machine learning models during the validation; ranking at least a second portion of the plurality of machine learning models based on the performance metrics, the configuration files, and the updated model performance requirements, wherein the second portion includes one or more additional machine learning models not included in the portion of the plurality of machine learning models; selecting a set of machine learning models from the second portion based on the ranking, wherein the set of machine learning models includes at least one of the one or more additional machine learning models; and modifying the given sequence of machine learning models to include the set of machine learning models.
Example 58 provides a computer-implemented method for generating personalized content based on user prompts, comprising: determining content generation parameters based on a user request for content generation received from a user and a plurality of user preferences associated with a user profile of the user; generating, based on the content generation parameters, a workflow for generating video content responsive to the user request for content generation, wherein the workflow includes a sequence of steps, a sequence of machine learning models each associated with a corresponding step from the sequence of steps, and an input adaptation layer that transforms different types of content into various forms of structured metadata depending on an input format associated with one or more of the set of machine learning models associated with a given step of the workflow; performing the sequence of steps of the workflow, wherein the content generation parameters are a first input for a first step in the sequence of steps, and wherein performing each of the subsequent steps of the sequence includes generating a corresponding input based on processing an output of a preceding step in the sequence with the input adaptation layer; subsequent to performing each given step in the sequence of steps of the workflow, causing a user device of the user to display a prompt for user feedback along with a content preview of any text content, visual content, or audio content generated during the given step; in response to receiving the user feedback associated with a particular instance of text content, visual content, or audio content generated during the given step, implementing acts comprising: determining an intended modification associated with the particular instance of text content, visual content, or audio content based on the user feedback; determining that one or more previous steps in the sequence of steps of the workflow are associated with downstream generation of the particular instance of text content, visual content, or audio content; modifying, based on the intended modification, one or more of the outputs generated during the one or more previous steps using the input adaptation layer to generate at least one modified input; re-generating the particular instances of text content, visual content, or audio content associated with the given step using the at least one modified input; and in response to completing the sequence of steps of the workflow, generating the video content that is responsive to the user request for content generation based on the outputs generated during the workflow, including the re-generated particular instances of text content, visual content, or audio content.
Example 59 provides the method of example 58, further comprising: in response to generating the video content, implementing acts comprising: causing a user device associated with the user to display the video content with an additional prompt for feedback; receiving user input responsive to the additional prompt that requests addition of an entity to the video content; determining that one or more particular steps in the sequence of steps of the workflow are associated with generation of the visual content or the audio content of a given scene in the video content; generating an additional input based on the entity; re-generating the visual content or the audio content of the given scene based on re-performing the one or more particular steps using the additional input; and generating updated video content based at least in part on the re-generated visual content or the re-generated audio content.
Example 60 provides the method of example 59, further comprising: determining that one or more corresponding machine learning models from the sequence of machine learning models that are associated with the one or more particular steps are not trained to generate visual data or audio data of the entity; obtaining a model configuration file associated with the entity from a database of model configuration files; generating one or more instances of training data for the one or more corresponding machine learning models based on the model configuration file, the content generation parameters, and the user input received responsive to the additional prompt for feedback; and training the one or more corresponding machine learning models using the one or more instances of training data.
Example 61 provides the method of example 58, further comprising: determining, based on comparing the content generation parameters to a plurality of templates in a template database, which template of the plurality of templates is most similar to the content generation parameters, wherein generating the workflow is further performed based on the determined template.
Example 62 provides the method of example 61, further comprising: generating, based on the determined template and the content generation parameters, a plurality of instances of audio training data each associated with a different voice fingerprint; ranking the plurality of instances of audio training data based on similarity of the different voice fingerprints to the determined template and the content generation parameters; selecting a given instance of audio training data from the plurality based on the ranking; and training a given machine learning model from the sequence of machine learning models to generate audio corresponding to the different voice fingerprint associated with the given instance of audio training data.
Example 63 provides the method of example 58, further comprising: updating the plurality of user preferences associated with the user profile of the user based on the feedback received from the user; updating other instances of user preferences associated with other user profiles of other users based on feedback received from the other users in response to corresponding content previews generated during other workflows; determining patterns of user preferences based on the updated plurality of user preferences and the updated other instances of user preferences; and modifying at least one input to at least one machine learning model in the sequence of machine learning models of the workflow based on at least one of the determined patterns.
Example 64 provides the method of example 58, further comprising: selecting the sequence of machine learning models from a plurality of machine learning models based on: determining input and output formats of the plurality of machine learning models; and determining a sequence of data transformations to transform the content generation parameters into the video content based on the determined input and output formats of the plurality of machine learning models.
Example 65 provides the method of example 58, wherein the re-generating includes re-generating any other particular instances of text content, visual content, or audio content associated with the one or more previous steps.
Example 66 provides the method of example 58, wherein the user request for content generation includes a reference image; and further comprising: determining at least one particular machine learning model from the sequence of machine learning models corresponds to at least one step from the sequence of steps that is associated with generating reference image data; generating training data for the at least one particular machine learning model using the reference image; and training the at least one particular machine learning model based on the training data.
Example 67 provides a system for an automated workflow that transforms user prompts into multimedia content using multiple artificial intelligence (“AI”) driven stages comprising: one or more processors, and memory storing instructions and operably coupled to the one or more processors, wherein execution of the instructions by the one or more processors causes the one or more processors to: receive user input indicating a user prompt for content generation provided by a user via a user device; perform a sequence of content generation steps associated with an automated workflow to generate video content responsive to the user prompt for content generation, wherein one or more of the content generation steps of the sequence are associated with at least one machine learning model selected from a plurality of machine learning models; monitor performance of the automated workflow based on monitoring outputs received from corresponding machine learning models from the plurality of machine learning models; generate, based on the monitoring, a biasing protocol for at least one machine learning model from the plurality of machine learning models associated with at least one content generation step in the sequence of content generation steps; bias the at least one machine learning model using the biasing protocol, wherein biasing the at least one machine learning model causes the at least one machine learning model to output different content during performance of the at least one content generation step after the biasing; repeat the automated workflow from the at least one content generation step using the biased at least one machine learning model, wherein repeating the automated workflow from the at least one content generation step includes repeating the at least one content generation step and any downstream content generation steps in the sequence; and cause a display associated with the user device of the user to display a video generated based on the different content generated by the at least one machine learning model during the at least one content generation step and based on other content generated by the plurality of machine learning models during other content generation steps in the sequence of content generation steps.
Example 68 provides the system of example 67, wherein performing the sequence of content generation steps of the automated workflow includes: generating reference data for downstream visual asset and audible asset generation based on the user prompt for content generation; generating visual content generation parameters and audible content generation parameters based on the reference data associated with downstream visual asset and audible asset generation using one or more second machine learning models from the plurality of machine learning models; generating a plurality of video clips based on processing the visual content generation parameters using one or more third machine learning models from the plurality of machine learning models, wherein the one or more third machine learning models are image-to-video models; generating a plurality of audio clips based on processing the audible content generation parameters using one or more fourth machine learning models from the plurality of machine learning models, wherein the one or more third machine learning models are text-to-sound models; and generating the video based on the plurality of video clips and the plurality of audio clips using one or more fifth machine learning models from the plurality of machine learning models.
Example 69 provides the system of example 68, wherein generating the reference data includes generating a reference table using one or more first machine learning models from the plurality of machine learning models, wherein the reference table includes a tabular representation of the reference data.
Example 70 provides the system of example 68, wherein the audible content generation parameters are in text format and the visual content generation parameters are in image format.
Example 71 provides the system of example 68, further comprising instructions for: generating text content indicating a narrative framework and script based on the user prompt for content generation using one or more additional machine learning models from the plurality of machine learning models, wherein generating the reference data is further performed based on the narrative framework and the script.
Example 72 provides the system of example 71, wherein generating the narrative framework and the script includes: determining one or more content templates from a plurality of content templates based on the user prompt for content generation; and determining characters, settings, and contexts associated with the narrative framework and the script based on the one or more content templates.
Example 73 provides the system of example 71, wherein generating the script includes generating a content timeline associated with the video content; and wherein generating the video content based on the plurality of video clips and the plurality of audio clips is performed based on the content timeline.
Example 74 provides the system of example 73, further comprising instructions for: generating content labels for the plurality of video clips and the plurality of audio clips with labels indicating a relative position within the content timeline using one or more additional machine learning models from the plurality of machine learning models, wherein the generated video content includes the plurality of video clips and the plurality of audio clips at the relative positions within the content timeline indicated by the corresponding labels.
Example 75 provides the system of example 67, further comprising instructions for: determining the plurality of machine learning models from a group of machine learning models by accessing a database of configuration files associated with the group of machine learning models; and determining the sequence of content generation steps required to generate the video content based on determining the plurality of machine learning models.
Example 76 provides the system of example 67, further comprising instructions for: generating a plurality of model biasing protocols for biasing one or more of the plurality of machine learning models to process inputs in a format corresponding to a preceding machine learning model associated with a preceding content generation step in the sequence; and biasing the plurality of machine learning models using the plurality of model biasing protocols prior to performing the sequence of content generation steps of the automated workflow to generate the video content.
Example 77 provides the system of example 67, further comprising instructions for: determining, based on the monitoring, a deficiency associated with a corresponding one of the outputs associated with a given machine learning model from the plurality of machine learning models, wherein the biasing protocol is generated based on the deficiency.
Example 78 provides the system of example 67, wherein performing the sequence of content generation steps associated with the automated workflow comprises performing an initial instance of the automated workflow; and wherein repeating the automated workflow includes performing a separate instance of the automated workflow.
Example 79 provides the system of example 78, further comprising instructions for: causing the display associated with the user device of the user to display an unmodified video generated based on the outputs of the plurality of machine learning models during the initial instance of the automated workflow.
Example 80 provides a system for maintaining narrative and visual consistency across multiple stages of a multimedia content generation process, comprising: one or more processors, and memory storing instructions and operably coupled to the one or more processors, wherein execution of the instructions by the one or more processors causes the one or more processors to: receive user input indicating a user prompt for content generation; determine an order of use for a set of machine learning models based on the user prompt for content generation, wherein order of use for the set of machine learning models is determined such that each machine learning model processes inputs in the order of use in a format corresponding to an output format of a preceding machine learning model; generate a dynamic reference table based on the user prompt for content generation and the order of use, the dynamic reference table including a plurality of entries each associated with at least one corresponding machine learning model from the set of machine learning models and each associated with reference data for visual or audible asset generation; perform a plurality of content generation processes in accordance with the order of use for the set of machine learning models, wherein performing the plurality of content generation processes includes updating the dynamic reference table to include outputs generated during the plurality of content generation processes including video clips and audio clips generated based on the reference data included in the dynamic reference table; generate updated reference data based on determining that particular reference data included in a particular entry from the plurality of entries in the dynamic reference table is associated with at least one of the outputs failing to satisfy one or more criteria; update at least one other entry from the plurality of entries of the dynamic reference table based on the updated reference data; re-generate downstream content starting from a point during the plurality of content generation processes corresponding to the at least one updated entry of the dynamic reference table; and generate video content responsive to the user prompt for content generation based on the video clips and the audio clips, wherein the video clips and the audio clips used to generate the video content exclude the at least one of the outputs that failed to satisfy the one or more criteria, and wherein at least one of the video clips or the audio clips includes the downstream content that was re-generated.
Example 81 provides the system of example 80, wherein the point during the plurality of content generation processes corresponding to the at least one updated entry corresponds to a point during the plurality of content generation processes preceding a later point that corresponds to when the at least one of the outputs was generated.
Example 82 provides the system of example 80, wherein determining that the particular reference data included in a particular entry from the plurality of entries in the dynamic reference table is associated with at least one of the outputs failing to satisfy one or more criteria includes comparing the outputs generated during the plurality of content generation processes to one or more of: benchmark criteria determined based on viewing metrics associated with other video content, another one or more of the outputs, and any of the outputs or the reference data included in one or more other entries from the plurality of entries in the dynamic reference table.
Example 83 provides the system of example 80, wherein generating the updated reference data includes generating multiple instances of updated reference data; and further comprising instructions for: generating additional video content responsive to the user prompt for content generation based on the outputs that were generated prior to updating the at least one other entry.
Example 84 provides the system of example 83, further comprising instructions for: causing a display device associated with a user device that provided the user input to display corresponding previews of the video content and the additional video content with a prompt for a user of the user device to select either the video content or the additional video content.
Example 85 provides the system of example 84, wherein the at least one other entry is associated with a particular machine learning model from the set of machine learning models; and further comprising instructions for: generating training data based on a user selection received responsive to the prompt.
Example 86 provides the system of example 85, further comprising instructions for: training at least one machine learning model based on the training data, wherein the at least one machine learning model includes one or more of: the particular machine learning model, and an additional machine learning model that determined that the at least one of the outputs did not satisfy the one or more criteria.
Example 87 provides the system of example 80, wherein updating the at least one other entry includes selecting the at least one other entry from the plurality of entries based on determining, based on the order of use for the set of machine learning models, that the at least one other entry is associated with one or more particular machine learning models from the set of machine learning models that provided intermediary output used to generate at least one of the inputs that was applied to a downstream, machine learning model according to the order of use for the set of machine learning models, wherein the downstream machine learning model generated the at least one of the outputs that failed to satisfy the one or more criteria.
Example 88 provides the system of example 87, further comprising instructions for: determining one or more templates that correspond to the user prompt for content generation from a plurality of templates included in a content generation template database, wherein the reference data in the dynamic reference table is generated based at least in part on the one or more determined templates.
Example 89 provides the system of example 88, wherein the set of machine learning models is selected from a plurality of machine learning models based at least in part on the one or more determined templates.
Example 90 provides the system of example 80, further comprising instructions for: processing the video content using an additional machine learning model trained to detect inconsistencies and discrepancies in synchronized video content; performing the updating and the re-generating processes responsive to the additional machine learning model detecting an inconsistency or a discrepancy; and re-generating the video content, wherein at least one of the video clips or the audio clips used to re-generate the video content includes the downstream content that was re-generated.
Example 91 provides the system of example 80, further comprising instructions for: determining the set of machine learning models from a plurality of machine learning models based on accessing a database of configuration files associated with the plurality of machine learning models, wherein the configuration files from the database define input content types and output content types associated with each of the plurality of machine learning models.
Example 92 provides the system of example 80, wherein the reference data in the dynamic reference table includes embedded references to character traits, key objects, and scene settings.
Example 93 provides the system of example 92, wherein updating the at least one other entry based on the alternative reference data includes modifying at least one particular embedded reference associated with the least one other entry, and wherein modifying the at least one embedded reference causes multiple other entries from the plurality of entries in the dynamic reference table that include the at least one particular embedded reference to be updated to include the modification to the at least one particular embedded reference.
Example 94 provides the system of example 93, wherein the multiple other entries include all other entries that include the at least one particular embedded reference.
Example 95 provides the system of example 93, wherein the multiple other entries include only other entries that include the at least one particular embedded reference and that are associated with current or downstream content generation processes in the plurality of content generation processes.
Example 96 provides the system of example 80, wherein each given entry from the plurality of entries of the dynamic reference table indicates one or more corresponding machine learning models from the set of machine learning models associated with a corresponding instance of the reference data indicated by the given entry.
Example 97 provides a system for optimizing inputs to downstream artificial intelligence (“AI”) models during an automated content generation workflow, comprising: one or more processors, and memory storing instructions and operably coupled to the one or more processors, wherein execution of the instructions by the one or more processors causes the one or more processors to: determine, based on a script generated responsive to a user prompt for content generation, a set of machine learning models and corresponding content generation parameters to be used during a sequence of content generation processes; generate a plurality of system prompts for biasing the set of machine learning models, wherein the plurality of system prompts are generated such that, after biasing the set of machine learning models, each biased machine learning model associated with a current content generation process in the sequence of content generation processes will process inputs in a format corresponding to outputs of a different machine learning model used during a previous content generation process in the sequence of content generation processes; bias the set of machine learning models using the plurality of system prompts; perform the sequence of content generation processes including generating: text content using one or more first biased large language models from the set of biased machine learning models and one or more of the corresponding content generation parameters, a reference table including visual reference data and audible reference data based on the text content using one or more second biased large language models from the set of biased machine learning models, video clips based on the visual reference data using at least one biased text-to-image model and at least one biased image-to-video model from the set of biased machine learning models, audio clips based on the audible reference data, the visual reference data, and the text content using one or more biased text-to-sound models from the set of biased machine learning models, and video content based on the video clips, the audio clips, and the reference table using one or more other biased machine learning models from the set of biased machine learning models; and in response to detecting, during performance of the sequence of content generation processes, a discrepancy between one or more of the outputs generated during a current content generation process and an input format associated with a given biased machine learning model from the set of biased machine learning models that is associated with a subsequent content generation process in the sequence of content generation processes, cause the one or more processors to: generate a modified input for the given biased machine learning model associated with the subsequent content generation process in the sequence of content generation processes; and cause at least a portion of the sequence of content generation processes associated with the given biased machine learning model to be performed again based on the modified input, wherein causing the at least a portion of the sequence of content generation processes associated with the given biased machine learning model to be performed again further causes other downstream content generation processes from the sequence of content generation processes to be performed again.
Example 98 provides the system of example 97, further comprising instructions for: performing a validation process associated with the current content generation process to validate performance of the given biased machine learning model based on comparing a given output generated by the given biased machine learning model based on the modified input to the visual reference data or the audible reference data in the reference table.
Example 99 provides the system of example 98, wherein causing the at least a portion of the sequence of content generation processes associated with the given biased machine learning model to be performed again based on the modified input is performed responsive to validating the performance of the given biased machine learning model.
Example 100 provides the system of example 98, further comprising instructions for: in response to being unable to validate the performance of the given biased machine learning model, causing the one or more processors to: generate an updated modified input; perform another validation process to validate performance of the given biased machine learning model with the updated modified input; and cause the at least a portion of the sequence of content generation processes associated with the given biased machine learning model to be performed again based on the updated modified input.
Example 101 provides the system of example 97, wherein causing the at least a portion of the sequence of content generation processes associated with the given biased machine learning model to be performed again based on the modified input includes generating second video clips that are different from the video clips previously generated; and further comprising instructions for: generating, based on comparing the video clips to the second video clips and further based on comparing the one or more of the outputs to the modified input, training data; and training the given biased machine learning model based on the training data.
Example 102 provides the system of example 97, wherein detecting the discrepancy is performed by an additional biased machine learning model from the set of biased machine learning models.
Example 103 provides the system of example 102, wherein generating the modified input is performed by the additional biased machine learning model.
Example 104 provides the system of example 102, wherein generating the modified input is performed by a different biased machine learning model from the set of biased machine learning models.
Example 105 provides the system of example 97, wherein generating the modified input for the biased given machine learning model associated with the subsequent content generation process includes generating the modified input using an additional biased machine learning model from the set of biased machine learning models, wherein the additional biased machine learning model is selected based on the discrepancy associated with the one or more outputs.
Example 106 provides the system of example 97, wherein the one or more biased text-to-sound models include multiple biased machine learning models from the set of biased machine learning models; and wherein generating the audio clips based on the audible reference data, the visual reference data, and the text content using the one or more biased text-to-sound models includes: generating a first portion of the audio clips based on applying inputs generated based on the audible reference data and the visual reference data to a first machine learning model of the multiple biased machine learning models, wherein the first machine learning model is a text-to-speech machine learning model; and generating a second portion of the audio clips based on applying inputs generated based on the audible reference data, the visual reference data, and at least a portion of the text content to a second machine learning model of the multiple biased machine learning models, wherein the second machine learning model is a text-to-sound machine learning model.
Example 107 provides the system of example 106, wherein generating the inputs based on the audible reference data and the visual reference data to apply to the first machine learning model and generating the inputs based on the audible reference data, the visual reference data, and at least a portion of the text content to apply to the second machine learning model are performed by respective different machine learning models from the multiple biased machine learning models.
Example 108 provides the system of example 97, wherein generating the video clips based on the visual reference data using the at least one biased text-to-image model and the at least one biased image-to-video model includes: generating training data for the at least one biased text-to-image model based on a first portion of the visual reference data; training the at least one biased text-to-image model using the training data; generating one or more reference images based on applying a second portion of the visual reference data as input to the at least one trained biased text-to-image model; generating video generation prompts based on a third portion of the visual reference data using an additional machine learning model of the multiple biased machine learning models; and generating the video clips based on applying the one or more reference images and the video generation prompts as inputs to the at least one biased image-to-video model.
Example 109 provides the system of example 97, wherein generating the video clips and the audio clips includes generating metadata associated with the video clips and the audio clips; and wherein generating the video content is performed further based on the metadata associated with the video clips and the audio clips.
Example 110 provides the system of example 97, wherein generating the modified input for the given biased machine learning model includes: generating a modified biasing protocol generated for a different biased machine learning model from the set of biased machine learning models that is associated with a preceding content generation process in the sequence of content generation processes based on the detected discrepancy; using the modified biasing protocol to re-bias the different biased machine learning model; and in response to re-biasing the different biased machine learning model associated with the preceding content generation process, causing the preceding content generation process to be performed again.
Example 111 provides the system of example 97, further comprising instructions for: in response to detecting, during performance of the sequence of content generation processes, an additional discrepancy between two or more of the outputs generated during two or more particular content generation processes of the sequence of content generation processes, causing the one or more processors to: generate an external input for at least one corresponding biased machine learning model from the set of biased machine learning models that are associated with at least one of the two or more particular content generation processes; and cause at least a given portion of the sequence of content generation processes associated with the at least one corresponding biased machine learning model to be performed again based on the external input, wherein causing the at least the given portion of the sequence of content generation processes associated with the one or more corresponding biased machine learning models to be performed again further causes other downstream content generation processes from the sequence of content generation processes to be performed again.
Example 112 provides the system of example 111, wherein the additional discrepancy is determined based on comparing at least one of the video clips to at least a portion of the visual reference data included in the reference table.
Example 113 provides the system of example 111, wherein the additional discrepancy is determined based on comparing at least one of the audio clips to at least a portion of the audible reference data included in the reference table.
Example 114 provides the system of example 97, wherein the set of biased machine learning models includes at least one prompt-generation agent that adapt inputs for one or more given content generation processes from the sequence of content generation processes; and wherein inputs for each of the one or more given content generation processes are generated by the corresponding at least one prompt-generation agent based on the outputs generated during one or more upstream content generation processes in the sequence of content generation processes and further based on one or more corresponding input formats associated with one or more corresponding biased machine learning models used during the given content generation process.
Example 115 provides a system for refining and optimizing future content generation workflows based on user feedback, comprising: one or more processors, and memory storing instructions and operably coupled to the one or more processors, wherein execution of the instructions by the one or more processors causes the one or more processors to: generate videos based on video segments generated using content generation reference tables, wherein each of the content generation reference tables includes entries associating content generation parameters and content generation models with a corresponding sequence of content generation steps; receive incidence information for viewer engagement actions taken by a plurality of viewers while the plurality of viewers were viewing the videos, wherein the incidence information is determined based at least in part on user input data from user devices associated with the plurality of viewers; determine, based on processing the incidence information in association with corresponding indications of associated videos from the videos and associated video segments from the videos segments using at least one machine learning model, patterns of viewer behavior associated with particular videos from the videos and particular video segments from the video segments; modify, for each given video segment from the particular video segments in each given particular video from the particular videos, corresponding entries from the entries in corresponding content generation reference tables from the content generation reference tables to include updated content generation parameters, wherein the updated content generation parameters are associated with modifying the patterns of viewer behavior associated with the respective video segment; and generate a plurality of new videos based on performing particular content generation steps from the corresponding sequences of content generation steps associated with the updated content generation parameters in the corresponding content generation reference tables, wherein the particular content generation steps include content generation steps associated with the corresponding entries including the updated content generation parameters and any downstream content generation steps in the corresponding sequences of content generation steps.
Example 116 provides the system of example 115, further comprising instructions for: receiving updated incidence information for a second set of viewer engagement actions taken by the plurality of viewers while the plurality of viewers were viewing the plurality of new videos; and determining corresponding improvement scores associated with the plurality of new videos.
Example 117 provides the system of example 116, further comprising instructions for: generating, based on the updated content generation parameters and the corresponding improvement scores, training data associated with at least one machine learning model that was used to process the updated content generation parameters; and training the at least one machine learning model based on the training data.
Example 118 provides the system of example 116, further comprising instructions for: determining a particular template from a plurality of corresponding templates that is associated with generating a particular one of the plurality of new videos associated with a particular one of the corresponding improvement scores; and generating a modified version of the particular template based on the updated content generation parameters and the particular one of the corresponding improvement scores.
Example 119 provides the system of example 115, further comprising instructions for: determining, for each respective video segment from the particular video segments and based on the corresponding content generation reference tables, corresponding points during the corresponding sequences of content generation steps associated with the respective video segments; and determining the downstream content generation steps based on the corresponding points during the corresponding sequences of generation steps associated with the respective video segments.
Example 120 provides the system of example 115, further comprising instructions for: storing, in a centralized feedback database, the incidence information with corresponding indications of the associated videos from the videos and the associated video segments from the video segments.
Example 121 provides the system of example 115, wherein modifying, for each given video segment from the particular video segments in each given particular video from the particular videos, the corresponding entries in the corresponding content generation reference tables to include the updated content generation parameters includes: generating, for each respective video segment from the particular video segments and based on the patterns of viewer behavior associated with the respective video segment, the updated content generation parameters associated with modifying the patterns of viewer behavior associated with the respective video segment; and storing the updated content generation parameters in the corresponding content generation reference tables in corresponding entries from the entries.
Example 122 provides the system of example 115, further comprising instructions for: identifying, for at least one video from the plurality of new videos, a plurality of different iterations of the at least one video that were generated based on different content generation parameters in the corresponding content generation reference table; and determining, based on incidence information for different viewer engagement actions taken by the plurality of viewers while the plurality of viewers were viewing the plurality of different iterations of the at least one video, a particular iteration of the different content generation parameters associated with satisfying one or more criteria.
Example 123 provides the system of example 122, further comprising instructions for: generating, based on determining the particular iteration of the different content generation parameters associated with satisfying the one or more criteria, modified content generation parameters for a different content generation reference table corresponding to a different video in the plurality of new videos; and generating a new version of the different video using the modified content generation parameters.
Example 124 provides the system of example 115, wherein the viewer engagement actions indicated by the incidence information include indications of one or more of: user selections, user view times, and viewer drop-off times.
Example 125 provides a computer-implemented system for a modular content generation workflow that enables swapping of artificial intelligence (“AI”) models without disrupting the workflow, comprising: one or more processors, and memory storing instructions and operably coupled to the one or more processors, wherein execution of the instructions by the one or more processors causes the one or more processors to: generate a database of performance metrics associated with a plurality of machine learning models that were used by a plurality of workflows to generate a plurality of videos, wherein each of the plurality of workflows uses multiple machine learning models from the plurality of machine learning models, and wherein the performance metrics are determined based on resource usage and outputs of the plurality of machine learning models during the plurality of workflows; determine, based on the database of performance metrics, that there is a discrepancy or deficiency in performance for a particular machine learning model from the plurality of machine learning models during a particular workflow from the plurality of workflows; determine, based on the database of performance metrics, an alternative machine learning model from the plurality of machine learning models to be used for the particular workflow; determine, based on accessing a database of configuration files for the plurality of machine learning models, a particular configuration file associated with the alternative machine learning model; configure the alternative machine learning model using the particular configuration file, wherein configuring the alternative machine learning model tailors the alternative machine learning model to particular input and output formats associated with the particular workflow; compare updated output generated using the configured alternative machine learning model to one or more content quality benchmarks associated with the particular workflow; and in response to validating an output quality of the configured alternative machine learning model based on the one or more content quality benchmarks, cause the one or more processors to: modify given workflows from the plurality of workflows that are associated with the determined particular workflow and include the particular machine learning model, wherein the modifying includes substituting the particular machine learning model with the configured alternative machine learning model in the given workflows; and in response to modifying the given workflows, cause the given workflows to re-generate any previously generated content that was generated during the given workflows by the particular machine learning model or was generated based on any inputs generated based on data included in intermediary outputs of the particular machine learning model.
Example 126 provides the system of example 125, wherein the plurality of workflows each define a sequence of content generation steps; and wherein causing the given workflows to re-generate the previously generated content is further performed for any downstream content generation steps in the sequences of content generation steps associated with the given workflows.
Example 127 provides the system of example 125, further comprising instructions for: determining a particular type of workflow from the plurality of workflows that corresponds to the discrepancy or deficiency in performance for the particular machine learning model, wherein the given workflows correspond to the particular type of workflow.
Example 128 provides the system of example 127, wherein determining, based on accessing the database of configuration files for the plurality of machine learning models, the particular configuration file associated with the alternative machine learning model is further performed based on determining that the particular configuration file is associated with the particular type of workflow.
Example 129 provides the system of example 125, wherein causing the given workflows to re-generate the previously generated content includes causing the given workflows to generate a plurality of updated videos; and further comprising instructions for: determining updated performance metrics for the plurality of updated videos; and modifying the given workflows by substituting the particular machine learning model for the configured alternative machine learning model in the given workflows based on the updated performance metrics.
Example 130 provides the system of example 125, wherein determining, based on the database of performance metrics, the alternative machine learning model to be used for the particular workflow includes: determining resource usage requirements of the plurality of machine learning models for the particular workflow; ranking the plurality of machine learning models based on the resource usage requirements for the particular workflow; and selecting the alternative machine learning model from the plurality of machine learning models based at least in part on the ranking.
Example 131 provides the system of example 125, wherein determining, based on the database of performance metrics, the alternative machine learning model to be used for the particular workflow includes: determining resource usage requirements of the plurality of machine learning models for the particular workflow; ranking the plurality of machine learning models based on the resource usage requirements for the particular workflow; and selecting the alternative machine learning model from the plurality of machine learning models based at least in part on the ranking.
Example 132 provides the system of example 125, further comprising instructions for: in response to failing to validate the output quality of the configured alternative machine learning model based on the one or more content quality benchmarks, causing the one or more processors to: determine, based on accessing the database of configuration files for the plurality of machine learning models, a different configuration file associated with the alternative machine learning model; re-configure the alternative machine learning model using the different configuration file; and compare second updated output generated using the re-configured alternative machine learning model to one or more content quality benchmarks associated with the particular workflow.
Example 133 provides the system of example 132, further comprising instructions for: re-configuring the alternative machine learning model using a plurality of different configuration files from the database of configuration files to generate a plurality of instances of the re-configured alternative machine learning model; comparing additional updated outputs generated using the plurality of instances of the re-configured alternative machine learning model; and selecting a given one of the plurality of different configuration files based on the comparisons of the additional updated outputs.
Example 134 provides a computer-implemented system for managing automated workflows for multi-layered content generation, comprising: one or more processors, and memory storing instructions and operably coupled to the one or more processors, wherein execution of the instructions by the one or more processors causes the one or more processors to: determine performance metrics for a plurality of machine learning models during performance of a plurality of content generation workflows, wherein each of the plurality of content generation workflows defines multiple sequences of machine learning models from the plurality of machine learning models; modify, based on the performance metrics, a given sequence of machine learning models from the multiple sequences of machine learning models for one or more given content generation workflow from the plurality of content generation workflows, wherein the modifying includes replacing one or more of the machine learning models from the one or more given sequences that are underperforming with alternative machine learning models from the plurality of machine learning models; re-perform one or more of previously performed steps of the one or more given content generation workflows that were performed using data generated by the underperforming machine learning models, wherein re-performing the previously performed steps of the one or more given content generation workflows includes generating one or more instances of updated content for each of the one or more given content generation workflows; validate performance of the alternative machine learning models based on comparing the one or more instances of updated content generated by the modified sequence of machine learning models to one or more instances of other content generated during a different sequence of machine learning models from the multiple sequences of machine learning models for the one or more given content generation workflows; and in response to validating the performance of the alternative machine learning models, cause the one or more processors to: generate, for each of the one or more given content generation workflows, video content based on outputs of the modified sequence of machine learning models, wherein the outputs include at least the one or more instances of updated content and the one or more instances of other content; and cause a plurality of user devices associated with a plurality of users who initiated performance of the one or more given content generation workflows to display the video content corresponding to the one or more given content generation workflows.
Example 135 provides the system of example 134, further comprising instructions for: in response to being unable to validate the performance of the alternative machine learning models, causing the one or more processors to: compare the one or more instances of updated content generated by the modified sequence of machine learning models to one or more previously generated instances of content that were generated by the given sequence of machine learning models prior to the modification; and determine, based on the performance metrics and the comparison between the one or more instances of updated content and the one or more previously generated instances of content, whether to modify the different sequence of machine learning models from the multiple sequences of machine learning models for the one or more given content generation workflows.
Example 136 provides the system of example 134, further comprising instructions for: propagating the one or more instances of updated content through at least one other sequence of machine learning models from the multiple sequences of machine learning models associated with the one or more given content generation workflows.
Example 137 provides the system of example 134, wherein validating the performance of the alternative machine learning models includes determining a relative position in a content timeline associated with each of the one or more instances of updated content and the one or more instances of other content.
Example 138 provides the system of example 137, wherein generating the video content is performed further based on synchronizing the one or more instances of updated content and the one or more instances of other content generated by the multiple sequences of machine learning models for the one or more given content generation workflows based on the determined content timeline.
Example 139 provides the system of example 134, further comprising instructions for: determining, based on accessing a database of configuration files associated with the plurality of machine learning models, a particular type of workflow from a plurality of types of workflows that is associated with one or more of the performance metrics, wherein the particular type of workflow defines a format for a sequence of inputs and outputs; and selecting the one or more given content generation workflows from the plurality of content generation workflows for modification based on determining that the one or more given content generation workflows correspond to the particular type of workflow.
Example 140 provides the system of example 137, further comprising instructions for: determining model performance requirements for the particular type of workflow based on the performance metrics and the configuration files; ranking a portion of the plurality of machine learning models based on the model performance requirements, wherein the portion includes the alternative machine learning models and at least one additional machine learning model; and selecting the alternative machine learning models from the plurality of machine learning models based on the ranking of the portion of the plurality of machine learning models.
Example 141 provides the system of example 140, further comprising instructions for: in response to being unable to validate the performance of the alternative machine learning models, causing the one or more processors to: determine updated model performance requirements based on new performance metrics generated for the alternative machine learning models during the validation; rank at least a second portion of the plurality of machine learning models based on the performance metrics, the configuration files, and the updated model performance requirements, wherein the second portion includes one or more additional machine learning models not included in the portion of the plurality of machine learning models; select a set of machine learning models from the second portion based on the ranking, wherein the set of machine learning models includes at least one of the one or more additional machine learning models; and modify the given sequence of machine learning models to include the set of machine learning models.
Example 142 provides a computer-implemented system for generating personalized content based on user prompts, comprising: one or more processors, and memory storing instructions and operably coupled to the one or more processors, wherein execution of the instructions by the one or more processors causes the one or more processors to: determine content generation parameters based on a user request for content generation received from a user and a plurality of user preferences associated with a user profile of the user; generate, based on the content generation parameters, a workflow for generating video content responsive to the user request for content generation, wherein the workflow includes a sequence of steps, a sequence of machine learning models each associated with a corresponding step from the sequence of steps, and an input adaptation layer that transforms different types of content into various forms of structured metadata depending on an input format associated with one or more of the set of machine learning models associated with a given step of the workflow; perform the sequence of steps of the workflow, wherein the content generation parameters are a first input for a first step in the sequence of steps, and wherein performing each of the subsequent steps of the sequence includes generating a corresponding input based on processing an output of a preceding step in the sequence with the input adaptation layer; subsequent to performing each given step in the sequence of steps of the workflow, cause a user device of the user to display a prompt for user feedback along with a content preview of any text content, visual content, or audio content generated during the given step; in response to receiving the user feedback associated with a particular instance of text content, visual content, or audio content generated during the given step, cause the one or more processors to: determine an intended modification associated with the particular instance of text content, visual content, or audio content based on the user feedback; determine that one or more previous steps in the sequence of steps of the workflow are associated with downstream generation of the particular instance of text content, visual content, or audio content; modify, based on the intended modification, one or more of the outputs generated during the one or more previous steps using the input adaptation layer to generate at least one modified input; re-generate the particular instances of text content, visual content, or audio content associated with the given step using the at least one modified input; and in response to completing the sequence of steps of the workflow, generate the video content that is responsive to the user request for content generation based on the outputs generated during the workflow, including the re-generated particular instances of text content, visual content, or audio content.
Example 143 provides the system of example 142, further comprising instructions for: in response to generating the video content, causing the one or more processors to: cause a user device associated with the user to display the video content with an additional prompt for feedback; receive user input responsive to the additional prompt that requests addition of an entity to the video content; determine that one or more particular steps in the sequence of steps of the workflow are associated with generation of the visual content or the audio content of a given scene in the video content; generate an additional input based on the entity; re-generate the visual content or the audio content of the given scene based on re-performing the one or more particular steps using the additional input; and generate updated video content based at least in part on the re-generated visual content or the re-generated audio content.
Example 144 provides the system of example 143, further comprising instructions for: determining that one or more corresponding machine learning models from the sequence of machine learning models that are associated with the one or more particular steps are not trained to generate visual data or audio data of the entity; obtaining a model configuration file associated with the entity from a database of model configuration files; generating one or more instances of training data for the one or more corresponding machine learning models based on the model configuration file, the content generation parameters, and the user input received responsive to the additional prompt for feedback; and training the one or more corresponding machine learning models using the one or more instances of training data.
Example 145 provides the system of example 142, further comprising instructions for: determining, based on comparing the content generation parameters to a plurality of templates in a template database, which template of the plurality of templates is most similar to the content generation parameters, wherein generating the workflow is further performed based on the determined template.
Example 146 provides the system of example 145, further comprising instructions for: generating, based on the determined template and the content generation parameters, a plurality of instances of audio training data each associated with a different voice fingerprint; ranking the plurality of instances of audio training data based on similarity of the different voice fingerprints to the determined template and the content generation parameters; selecting a given instance of audio training data from the plurality based on the ranking; and training a given machine learning model from the sequence of machine learning models to generate audio corresponding to the different voice fingerprint associated with the given instance of audio training data.
Example 147 provides the system of example 142, further comprising instructions for: updating the plurality of user preferences associated with the user profile of the user based on the feedback received from the user; updating other instances of user preferences associated with other user profiles of other users based on feedback received from the other users in response to corresponding content previews generated during other workflows; determining patterns of user preferences based on the updated plurality of user preferences and the updated other instances of user preferences; and modifying at least one input to at least one machine learning model in the sequence of machine learning models of the workflow based on at least one of the determined patterns.
Example 148 provides the system of example 142, further comprising instructions for: selecting the sequence of machine learning models from a plurality of machine learning models based on: determining input and output formats of the plurality of machine learning models; and determining a sequence of data transformations to transform the content generation parameters into the video content based on the determined input and output formats of the plurality of machine learning models.
Example 149 provides the system of example 142, wherein the re-generating includes re-generating any other particular instances of text content, visual content, or audio content associated with the one or more previous steps.
Example 150 provides the system of example 142, wherein the user request for content generation includes a reference image; and further comprising instructions for: determining at least one particular machine learning model from the sequence of machine learning models corresponds to at least one step from the sequence of steps that is associated with generating reference image data; generating training data for the at least one particular machine learning model using the reference image; and training the at least one particular machine learning model based on the training data.
Example 151 provides one or more computing systems, comprising: one or more processors; and memory storing instructions and operably coupled to the one or more processors, wherein execution of the instructions by the one or more processors causes the one or more processors to implement the computer-implemented methods of any one of examples 1 through 66, or the claims filed herewith.
Example 152 provides a machine-readable medium carrying machine readable instructions, which when executed by a processor of a machine, causes the machine to carry out one or more of the instructions of any one of the methods examples 1 to 66, or filed herewith or system examples 67 to 150.
Example 153 provides an apparatus, machine, a computer-implemented method, a computer-implemented system, a computing system, and/or a machine-readable medium comprising any combination of one or more features of one of the methods examples 1 to 66, or filed herewith or system examples 67 to 150.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

It should be understood that the individual operations used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A computer-implemented method for an automated workflow that transforms user prompts into multimedia content using multiple artificial intelligence (“AI”) driven stages, comprising:
receiving user input indicating a user prompt for content generation provided by a user via a user device;
performing a sequence of content generation steps associated with an automated workflow to generate video content responsive to the user prompt for content generation, wherein one or more of the content generation steps of the sequence are associated with at least one machine learning model selected from a plurality of machine learning models;
monitoring performance of the automated workflow based on monitoring outputs received from corresponding machine learning models from the plurality of machine learning models;
generating, based on the monitoring, a biasing protocol for at least one machine learning model from the plurality of machine learning models associated with at least one content generation step in the sequence of content generation steps;
biasing the at least one machine learning model using the biasing protocol, wherein biasing the at least one machine learning model causes the at least one machine learning model to output different content during performance of the at least one content generation step after the biasing; and
repeating the automated workflow from the at least one content generation step using the biased at least one machine learning model, wherein repeating the automated workflow from the at least one content generation step includes repeating the at least one content generation step and any downstream content generation steps in the sequence; and
causing a display associated with the user device of the user to display a video generated based on the different content generated by the at least one machine learning model during the at least one content generation step and based on other content generated by the plurality of machine learning models during other content generation steps in the sequence of content generation steps.

2. The method of claim 1, wherein performing the sequence of content generation steps of the automated workflow includes:
generating reference data for downstream visual asset and audible asset generation based on the user prompt for content generation;
generating visual content generation parameters and audible content generation parameters based on the reference data associated with downstream visual asset and audible asset generation using one or more second machine learning models from the plurality of machine learning models;
generating a plurality of video clips based on processing the visual content generation parameters using one or more third machine learning models from the plurality of machine learning models, wherein the one or more third machine learning models are image-to-video models;
generating a plurality of audio clips based on processing the audible content generation parameters using one or more fourth machine learning models from the plurality of machine learning models, wherein the one or more third machine learning models are text-to-sound models; and
generating the video based on the plurality of video clips and the plurality of audio clips using one or more fifth machine learning models from the plurality of machine learning models.

3. The method of claim 2, further comprising:
generating text content indicating a narrative framework and script based on the user prompt for content generation using one or more additional machine learning models from the plurality of machine learning models, wherein generating the reference data is further performed based on the narrative framework and the script.

4. The method of claim 3, wherein generating the script includes generating a content timeline associated with the video content; and wherein generating the video content based on the plurality of video clips and the plurality of audio clips is performed based on the content timeline.

5. The method of claim 4, further comprising:
generating content labels for the plurality of video clips and the plurality of audio clips with labels indicating a relative position within the content timeline using one or more additional machine learning models from the plurality of machine learning models,
wherein the generated video content includes the plurality of video clips and the plurality of audio clips at the relative positions within the content timeline indicated by the corresponding labels.

6. The method of claim 1, further comprising:
determining the plurality of machine learning models from a group of machine learning models by accessing a database of configuration files associated with the group of machine learning models; and
determining the sequence of content generation steps required to generate the video content based on determining the plurality of machine learning models.

7. The method of claim 1, further comprising:
generating a plurality of model biasing protocols for biasing one or more of the plurality of machine learning models to process inputs in a format corresponding to a preceding machine learning model associated with a preceding content generation step in the sequence; and
biasing the plurality of machine learning models using the plurality of model biasing protocols prior to performing the sequence of content generation steps of the automated workflow to generate the video content.

8. The method of claim 1, further comprising:
determining, based on the monitoring, a deficiency associated with a corresponding one of the outputs associated with a given machine learning model from the plurality of machine learning models, wherein the biasing protocol is generated based on the deficiency.

9. The method of claim 1, wherein performing the sequence of content generation steps associated with the automated workflow comprises performing an initial instance of the automated workflow; and wherein repeating the automated workflow includes performing a separate instance of the automated workflow.

10. The method of claim 9, further comprising:
causing the display associated with the user device of the user to display an unmodified video generated based on the outputs of the plurality of machine learning models during the initial instance of the automated workflow.

11. A computer-implemented method for maintaining narrative and visual consistency across multiple stages of a multimedia content generation process, comprising:
receiving user input indicating a user prompt for content generation;
determining an order of use for a set of machine learning models based on the user prompt for content generation, wherein order of use for the set of machine learning models is determined such that each machine learning model processes inputs in the order of use in a format corresponding to an output format of a preceding machine learning model;
generating a dynamic reference table based on the user prompt for content generation and the order of use, the dynamic reference table including a plurality of entries each associated with at least one corresponding machine learning model from the set of machine learning models and each associated with reference data for visual or audible asset generation;
performing a plurality of content generation processes in accordance with the order of use for the set of machine learning models, wherein performing the plurality of content generation processes includes updating the dynamic reference table to include outputs generated during the plurality of content generation processes including video clips and audio clips generated based on the reference data included in the dynamic reference table;
generating updated reference data based on determining that particular reference data included in a particular entry from the plurality of entries in the dynamic reference table is associated with at least one of the outputs failing to satisfy one or more criteria;
updating at least one other entry from the plurality of entries of the dynamic reference table based on the updated reference data;
re-generating downstream content starting from a point during the plurality of content generation processes corresponding to the at least one updated entry of the dynamic reference table; and
generating video content responsive to the user prompt for content generation based on the video clips and the audio clips, wherein the video clips and the audio clips used to generate the video content exclude the at least one of the outputs that failed to satisfy the one or more criteria, and wherein at least one of the video clips or the audio clips includes the downstream content that was re-generated.

12. The method of claim 11, wherein the point during the plurality of content generation processes corresponding to the at least one updated entry corresponds to a point during the plurality of content generation processes preceding a later point that corresponds to when the at least one of the outputs was generated.

13. The method of claim 11, wherein updating the at least one other entry includes selecting the at least one other entry from the plurality of entries based on determining, based on the order of use for the set of machine learning models, that the at least one other entry is associated with one or more particular machine learning models from the set of machine learning models that provided intermediary output used to generate at least one of the inputs that was applied to a downstream, machine learning model according to the order of use for the set of machine learning models, wherein the downstream machine learning model generated the at least one of the outputs that failed to satisfy the one or more criteria.

14. The method of claim 13, further comprising:
determining one or more templates that correspond to the user prompt for content generation from a plurality of templates included in a content generation template database, wherein the reference data in the dynamic reference table is generated based at least in part on the one or more determined templates.

15. The method of claim 14, wherein the set of machine learning models is selected from a plurality of machine learning models based at least in part on the one or more determined templates.

16. The method of claim 11, further comprising:
processing the video content using an additional machine learning model trained to detect inconsistencies and discrepancies in synchronized video content;
performing the updating and the re-generating processes responsive to the additional machine learning model detecting an inconsistency or a discrepancy; and
re-generating the video content, wherein at least one of the video clips or the audio clips used to re-generate the video content includes the downstream content that was re-generated.

17. The method of claim 11, further comprising:
determining the set of machine learning models from a plurality of machine learning models based on accessing a database of configuration files associated with the plurality of machine learning models, wherein the configuration files from the database define input content types and output content types associated with each of the plurality of machine learning models.

18. The method of claim 11, wherein the reference data in the dynamic reference table includes embedded references to character traits, key objects, and scene settings.

19. The method of claim 18, wherein updating the at least one other entry based on the alternative reference data includes modifying at least one particular embedded reference associated with the least one other entry, and wherein modifying the at least one embedded reference causes multiple other entries from the plurality of entries in the dynamic reference table that include the at least one particular embedded reference to be updated to include the modification to the at least one particular embedded reference.

20. The method of claim 19, wherein the multiple other entries include all other entries that include the at least one particular embedded reference.

21. The method of claim 19, wherein the multiple other entries include only other entries that include the at least one particular embedded reference and that are associated with current or downstream content generation processes in the plurality of content generation processes.

22. The method of claim 11, wherein each given entry from the plurality of entries of the dynamic reference table indicates one or more corresponding machine learning models from the set of machine learning models associated with a corresponding instance of the reference data indicated by the given entry.
